(19) United States
(12) Patent Application Publication
(10) Pub. No.: US 2026/0098491 A1
(43) Pub. Date: Apr. 9, 2026

(54) SYSTEMS AND METHODS FOR DOSER BIAS DETECTION IN AFTERTREATMENT SYSTEMS

(71) Applicant: CUMMINS EMISSION SOLUTIONS INC., Columbus, IN (US)

(72) Inventors: Jinqian Gong, Columbus, IN (US); Ruinan Yang, Columbus, IN (US)

(73) Assignee: CUMMINS EMISSION SOLUTIONS INC., Columbus, IN (US)

(21) Appl. No.: 18/905,901

(22) Filed: Oct. 3, 2024

(51) Int. Cl. F01N 3/20

(52) U.S. Cl. CPC F01N 3/208; F01N 2560/026; F01N 2570/14; F01N 2610/02; F01N 2610/146; F01N 2900/1614; F01N 2900/1616; F01N 2900/1621

(57) ABSTRACT

A non-transitory computer-readable medium having computer-readable instructions stored thereon that, when executed by at least one controller, cause the at least one controller to: determine, for a time interval, an estimated deNOₓ—NH₃ ratio; and control an amount of reductant inserted into the decomposition chamber based on at least the estimated deNOₓ—NH₃ ratio.

### TECHNICAL FIELD

The present disclosure relates to bias detection in aftertreatment systems. More specifically, the present disclosure relates to detecting whether a doser of an aftertreatment system is underdosing or overdosing.

### BACKGROUND

Exhaust aftertreatment systems are used to receive and treat exhaust gas generated by engines such as internal combustion (IC) engines. Exhaust gas aftertreatment systems include any of several different components to reduce the levels of harmful exhaust emissions present in exhaust gas.

### SUMMARY

An aftertreatment system includes a doser which can dose reductant into a decomposition chamber of the aftertreatment system. The aftertreatment system includes a catalyst (e.g., selective catalytic reduction catalyst) which can catalyze decomposition of NOₓ gases in the presence of reductant. The aftertreatment system may enter a state in which the doser is underdosing or overdosing reductant (e.g., due to existing bias). An aftertreatment system in which the doser is underdosing reductant is said to have negative bias and an aftertreatment system in which the doser is overdosing reductant is said to have positive bias. If the aftertreatment system has negative or positive bias, the aftertreatment system can emit more NOₓ or NH₃ compared to an aftertreatment system that does not have bias. Detection of negative and/or positive bias in the aftertreatment system allows for improved dosing strategy and lower NOₓ emissions and/or NH₃ emissions.

At least one aspect of the present disclosure is directed to a non-transitory computer-readable medium for use with an aftertreatment system that includes a catalyst and a decomposition chamber upstream of the catalyst. The medium has computer-readable instructions stored thereon that, when executed by at least one controller, cause the at least one controller to determine, for a time interval, an estimated deNOₓ—NH₃ ratio defined by:

$$estimated {deNO}_{x} - {NH}_{3} ratio = \frac{a c c u m u lated inlet {NO}_{x} - accumulated outlet {NO}_{x}}{injected {NH}_{3} + N {H}_{3} storage change - N {H}_{3} slip} ,$$

wherein the accumulated inlet NOₓ includes an amount of NOₓ in exhaust gas at an inlet of the catalyst, the accumulated outlet NOₓ includes an amount of NOₓ in the exhaust gas at an outlet of the catalyst, the injected NH₃ includes an amount of NH₃ injected into the decomposition chamber, the NH₃ storage change includes a change of an amount of NH₃ stored in the catalyst, and the NH₃ slip includes an amount of NH₃ at an outlet of the aftertreatment system. The at least one controller can control an amount of reductant inserted into the decomposition chamber based on at least the estimated deNOₓ—NH₃ ratio.

Another aspect of the present disclosure is directed to an aftertreatment system. The aftertreatment system can include at least one controller. The at least one controller can determine, for a time interval, an estimated deNOₓ—NH₃ ratio defined by:

$$estimated {deNO}_{x} - {NH}_{3} ratio = \frac{a c c u m u lated inlet {NO}_{x} - accumulated outlet {NO}_{x}}{injected {NH}_{3} + N {H}_{3} storage change - N {H}_{3} slip} ,$$

wherein the accumulated inlet NOₓ includes an amount of NOₓ in exhaust gas at an inlet of the catalyst, the accumulated outlet NOₓ includes an amount of NOₓ in the exhaust gas at an outlet of the catalyst, the injected NH₃ includes an amount of NH₃ injected into the decomposition chamber, the NH₃ storage change includes a change of an amount of NH₃ stored in the catalyst, and the NH₃ slip includes an amount of NH₃ at an outlet of the aftertreatment system. The at least one controller can control an amount of reductant inserted into the decomposition chamber based on at least the estimated deNOₓ—NH₃ ratio.

Another aspect of the present disclosure is directed to a method. The method can include determining, by at least one controller, for a first time interval, an average of a first plurality of SONOₓ values for an aftertreatment system that includes a catalyst and a decomposition chamber upstream of the catalyst. The method can include determining, by the at least one controller, for a second time interval, an average of a second plurality of SONOₓ values for the aftertreatment system. The method can include determining, by the at least one controller, whether the average of the first plurality of SONOₓ values is greater than a first threshold value. The method can include determining, by the at least one controller, whether the average of the second plurality of SONOₓ values is greater than the first threshold value. The method can include determining, by the at least one controller, whether NH₃ slip has occurred during the first time interval and the second time interval. The method can include controlling, by the at least one controller, an amount of reductant inserted into the decomposition chamber based on at least a determination that the average of the first plurality of SONOₓ values is greater than the first threshold value, a determination that the average of the second plurality of SONOₓ values is greater than the first threshold value, and a determination that NH₃ slip has not occurred during the first time interval and the second time interval.

Another aspect of the present disclosure is directed to a non-transitory computer-readable medium for use with an aftertreatment system that includes a catalyst and a decomposition chamber upstream of the catalyst. The medium has computer-readable instructions stored thereon that, when executed by at least one controller, cause the at least one controller to determine a time interval when accumulated inlet NOₓ is greater than a first threshold value. The at least one controller can determine a first SONOₓ value when a first NH₃ target is greater than a first NH₃ storage for the time interval. The at least one controller can determine a second SONOₓ value when a second NH₃ storage is greater than a second NH₃ target for the time interval. The at least one controller can determine a ratio between the first SONOₓ value and the second SONOₓ value. The at least one controller can determine a maximum SONOₓ value when the second NH₃ storage is greater than the second NH₃ target. The at least one controller can determine a minimum SONOₓ value when the second NH₃ storage is greater than the second NH₃ target. The at least one controller can determine a ratio between the maximum SONOₓ value and the minimum SONOₓ value. The at least one controller can control an amount of reductant inserted into the decomposition chamber based on at least one of the ratio between the first SONOₓ value and the second SONOₓ value or the ratio between the maximum SONO value and the minimum SONOₓ value.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

A clear conception of the advantages and features constituting the present disclosure, and of the construction and operation of typical mechanisms provided with the present disclosure, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a schematic diagram of an aftertreatment system, according to an example implementation.

FIG. 2 illustrates a block diagram of a controller of the aftertreatment system of FIG. 1, according to an example implementation.

FIG. 3 illustrates a process diagram for performing a bias detection check, according to an example implementation.

FIG. 4 illustrates a process diagram for performing Check A of the bias detection check of FIG. 3, according to an example implementation.

FIG. 5 illustrates a process diagram for performing Check B of the bias detection check of FIG. 3, according to an example implementation.

FIG. 6 illustrates a process diagram for performing Check C of the bias detection check of FIG. 3, according to an example implementation.

FIG. 7 illustrates a process diagram for performing Check D of the bias detection check of FIG. 3, according to an example implementation.

FIG. 8 illustrates a block diagram for controlling an amount of reductant inserted into a decomposition chamber of the aftertreatment system, according to an example implementation.

FIG. 9 illustrates a block diagram for controlling an amount of reductant inserted into the decomposition chamber of the aftertreatment system, according to an example implementation.

FIG. 10 illustrates a block diagram for controlling an amount of reductant inserted into the decomposition chamber of the aftertreatment system, according to an example implementation.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Internal combustion engine emissions, such as from a diesel engine, can include nitrogen oxides (NOₓ) which can be harmful for environment and human health. The NOₓ in the exhaust from the engine can be reduced or eliminated by reacting the NOₓ with urea injected into an aftertreatment system (e.g., a decomposition chamber of the aftertreatment system) that includes a catalyst (e.g., selective catalytic reduction catalyst). When the doser is underdosing urea (e.g., has a negative bias) or overdosing urea (e.g., has a positive bias), the amount of urea injected into the system may be sub-optimal, which can cause higher NOₓ emissions and/or NH₃ emissions.

### Overview of Exhaust Gas Aftertreatment Systems

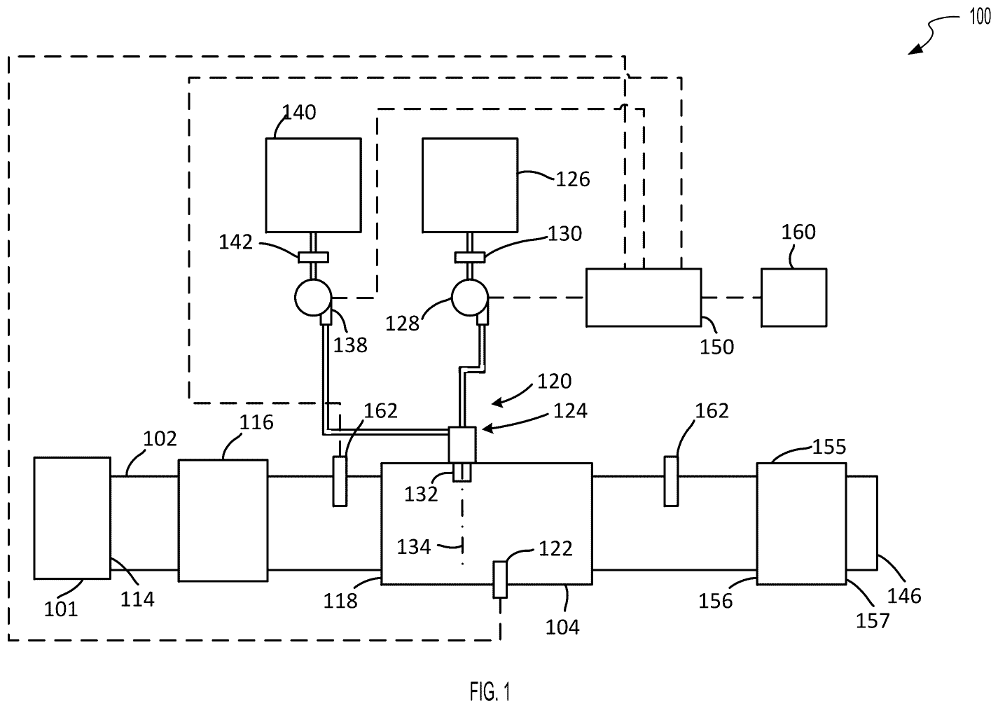

FIG. 1 depicts an aftertreatment system 100 (e.g., exhaust aftertreatment system, exhaust gas aftertreatment system). The aftertreatment system 100 is configured to receive exhaust gas (e.g., diesel exhaust gas, etc.) from an engine 101 (e.g., internal combustion engine, etc.) and treat constituents (e.g., NOₓ, CO, CO₂, etc.) of the exhaust gas. The engine 101 is configured to (e.g., structured to, able to, etc.) receive a fluid mixture of fuel (e.g., diesel, gasoline, hydrogen, etc.) and air, combust the fluid mixture, and provide an exhaust based on combustion of the fluid mixture. The engine 101 may include, for example, a diesel engine, a gasoline engine, a natural gas engine, a dual fuel engine, a biodiesel engine, an E-85 engine, or any other suitable engine. The engine 101 combusts fuel and generates an exhaust gas that includes NOₓ, CO, CO₂, and other constituents. The engine 101 may include other components, for example, a transmission, fuel insertion assemblies, or a generator or alternator to convert the mechanical power produced by the engine 101 into electrical power.

The aftertreatment system 100 can include a housing 104 (e.g., casing, cover, container, shell, etc.) in which various aftertreatment components of the aftertreatment system 100 are disposed. The housing 104 may be formed from a rigid, heat-resistant and corrosion-resistant material, for example stainless steel, iron, aluminum, metals, ceramics, or any other suitable material. The housing 104 may have any suitable cross-section, for example, circular, square, rectangular, oval, elliptical, polygonal, or any other suitable shape.

The aftertreatment system 100 can include an exhaust conduit 102 (e.g., channel, duct, pipe, tube, chute, conduit, etc.) that is fluidly coupled to the engine 101. The exhaust conduit 102 is structured to receive exhaust gas from the engine 101 via an inlet 114. The exhaust conduit 102 is structured to release treated exhaust via outlet 146. Treated exhaust can include exhaust that has been treated to removed particulate matter and/or reduced constituents of the exhaust gas such as NOₓ gases, CO, unburnt hydrocarbons, etc.

The aftertreatment system 100 can include a particulate filter 116 (e.g., a diesel particulate filter (DPF), filter, etc.). The particulate filter 116 is disposed in the exhaust conduit 102. The particulate filter 116 is coupled to the exhaust conduit 102 and is configured to remove particulate matter, such as soot, from the exhaust flowing in the exhaust conduit 102. The particulate filter 116 can include an inlet, where the exhaust is received, and an outlet, where the exhaust exits after having particulate matter substantially filtered from the exhaust and/or converting the particulate matter into CO₂. In some embodiments, the particulate filter 116 may include a ceramic filter. In some embodiments, the particulate filter 116 may include a cordierite filter which can, for example, be an asymmetric filter.

The aftertreatment system 100 can include a decomposition chamber 118 (e.g., reactor, reactor pipe, conduit, housing, etc.) disposed downstream of the filter 116. The decomposition chamber 118 is configured to receive the exhaust from the particulate filter 116. The decomposition chamber 118 can include an inlet in fluid communication with the particulate filter 116. The decomposition chamber 118 can include an outlet for the exhaust, NOₓ emissions, and/or ammonia to flow to downstream components of the aftertreatment system 100.

The aftertreatment system 100 can include a treatment fluid delivery system 120. The treatment fluid delivery system 120 can be coupled to the decomposition chamber 118. The treatment fluid delivery system 120 is configured to deliver treatment fluid to the decomposition chamber 118. The treatment fluid may be, for example, a reductant (e.g., a urea, a diesel exhaust fluid (DEF), Adblue®, a urea water solution (UWS), an aqueous urea solution (e.g., AUS32, etc.), ammonia and/or other similar fluids) or a hydrocarbon fluid (e.g., a fuel, an oil, an additive, etc.). When the reductant is introduced into the exhaust, reduction of emission of undesirable components (e.g., NOₓ, etc.) in the exhaust may be facilitated. When the hydrocarbon fluid is introduced into the exhaust, the temperature of the exhaust may be increased (e.g., to facilitate regeneration of components of the aftertreatment system 100, etc.). For example, the aftertreatment system 100 may include an igniter 122 (e.g., spark plug, etc.) configured to increase the temperature of the exhaust by combusting the hydrocarbon fluid within the exhaust. The inlet of the decomposition chamber 118 can receive the exhaust containing NOₓ emissions. The outlet of the decomposition chamber 118 can output exhaust, NOₓ emissions, ammonia, and/or the treatment fluid to flow to downstream components of the aftertreatment system 100.

The treatment fluid delivery system 120 can include a doser assembly 124 (e.g., a dosing module, reductant insertion assembly, doser etc.) configured to dose the treatment fluid into the decomposition chamber 118 (e.g., via an injector). The doser assembly 124 is mounted to the decomposition chamber 118 such that the doser assembly 124 may dose the treatment fluid into the exhaust flowing through the exhaust conduit 102.

The doser assembly 124 can be fluidly coupled to (e.g., fluidly configured to communicate with, etc.) a treatment fluid source 126. The treatment fluid source 126 may include multiple treatment fluid sources 126. The treatment fluid source 126 may be, for example, a diesel exhaust fluid tank containing Adblue®. A treatment fluid pump 128 (e.g., a supply unit, etc.) is used to pressurize the treatment fluid from the treatment fluid source 126 for delivery to the doser assembly 124. In some embodiments, the treatment fluid pump 128 is pressure-controlled (e.g., controlled to obtain a target pressure, etc.). The treatment fluid pump 128 may include a treatment fluid filter 130. The treatment fluid filter 130 filters (e.g., strains, etc.) the treatment fluid prior to the treatment fluid being provided to internal components (e.g., pistons, vanes, etc.) of the treatment fluid pump 128. For example, the treatment fluid filter 130 may inhibit or prevent the transmission of solids (e.g., solidified treatment fluid, contaminants, etc.) to the internal components of the treatment fluid pump 128. In this way, the treatment fluid filter 130 may facilitate prolonged desirable operation of the treatment fluid pump 128.

The doser assembly 124 can include at least one injector 132 (e.g., reductant injector). Each injector 132 is configured to dose the treatment fluid into the exhaust (e.g., within the decomposition chamber 118, etc.). The injector 132 is configured to insert reductant (e.g., a combined flow of reductant and compressed air) into the decomposition chamber 118.

The treatment fluid delivery system 120 may include an air pump 138. The air pump 138 draws air from an air source 140 (e.g., an air intake, etc.) through an air filter 142 disposed upstream of the air pump 138 and provides the air to the doser assembly 124 via a conduit. In these embodiments, the doser assembly 124 is configured to mix the air and the treatment fluid into an air-treatment fluid mixture and to provide the air-treatment fluid mixture into the decomposition chamber 118. In other embodiments, the treatment fluid delivery system 120 does not include the air pump 138, the air source 140, and/or the air filter 142. In such embodiments, the doser assembly 124 is not configured to mix the treatment fluid with the air.

The aftertreatment system 100 can include a catalyst system 155. The catalyst system 155 is configured to decompose constituents of the exhaust gas flowing through the exhaust conduit 102. In some embodiments, the catalyst system 155 includes a catalyst member (e.g., a selective catalytic reduction (SCR) catalyst member, SCR catalyst, etc.) disposed downstream of the decomposition chamber 118. As a result, the treatment fluid is injected upstream of the catalyst member such that the catalyst member receives a mixture of the treatment fluid and exhaust. Droplets of the treatment fluid undergo processes of evaporation, thermolysis, and hydrolysis to form non-NOₓ emissions (e.g., gaseous ammonia, etc.) within the exhaust conduit 102. The SCR catalyst is configured to catalyze decomposition of NOₓ gases into its constituents in the presence of a reductant. Any suitable SCR catalyst may be used such as, for example, platinum, palladium, rhodium, cerium, iron, manganese, copper, vanadium-based catalyst, any other suitable catalyst, or a combination thereof. The SCR catalyst may be disposed on a suitable substrate such as, for example, a ceramic (e.g., cordierite) or metallic (e.g., kanthal) monolith core that can, for example, define a honeycomb structure. In other embodiments, the catalyst system 155 includes an oxidation catalyst member (e.g., a diesel oxidation catalyst (DOC), an ammonia oxidation catalyst (AMO_{X}), etc.). The oxidation catalyst member can oxidize hydrocarbons and carbon monoxide in the exhaust. In yet other embodiments, the catalyst system 155 includes a particulate filter (e.g., the particulate filter 116, etc.).

The catalyst system 155 can include an upstream face in fluid communication with the decomposition chamber 118 from which the exhaust and the treatment fluid are received. The upstream face can include an inlet 156 of the catalyst. The catalyst system 155 can include a downstream face in fluid communication with the outlet 146 of the exhaust conduit 102. The downstream face can include an outlet 157 of the catalyst. The outlet 146 may release the treated exhaust into an ambient environment or another treatment system. In some embodiments, the particulate filter 116 may be positioned downstream of the decomposition chamber 118. For instance, the particulate filter 116 and the catalyst system 155 may be combined into a single unit.

The aftertreatment system 100 can include a controller 150 (e.g., a treatment fluid delivery system controller, etc.). The controller 150 is electrically or communicatively coupled to the igniter 122. The controller 150 may control the igniter 122 to ignite the treatment fluid in the decomposition chamber 118. For example, where the controller 150 may cause the igniter 122 to provide an electrical arc in a region traversed by the hydrocarbon fluid, and the electrical arc may ignite the hydrocarbon fluid. The controller 150 is electrically or communicatively coupled to the doser assembly 124. The controller 150 may control the doser assembly 124 to dose the treatment fluid into the decomposition chamber 118. The controller 150 is electrically or communicatively coupled to the treatment fluid pump 128 and/or the air pump 138. The controller 150 may also control operations of the treatment fluid pump 128 and/or the air pump 138. The controller 150 is electrically or communicatively coupled to the engine 101. The controller 150 may also control operations of the engine 101 (e.g., spark plug ignition, fuel injection, etc.).

The controller 150 can include a processing circuit. The processing circuit can include a processor and a memory. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing the processor with program instructions. This memory may include a memory chip, Electrically Erasable Programmable Read-Only Memory (EEPROM), Erasable Programmable Read Only Memory (EPROM), flash memory, or any other suitable memory from which the controller 150 can read instructions. The instructions may include code from any suitable programming language. The memory may include various modules that include instructions which are configured to be implemented by the processor.

The controller 150 may be configured to communicate with a central controller 160 (e.g., engine control unit (ECU), engine control module (ECM), etc.) of the engine 101. In some embodiments, the central controller 160 and the controller 150 are integrated into a single controller. In some embodiments, the central controller 160 is communicable with a display device (e.g., a screen, a monitor, a touch screen, a heads up display (HUD), an indicator light, etc.). The display device may be configured to change state in response to receiving information from the central controller 160. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller 160. By changing state, the display device may provide an indication to a user (e.g., an operator, a technician, etc.) of a status (e.g., operation, in need of service, etc.) of the treatment fluid delivery system 120 and/or the aftertreatment system 100.

The aftertreatment system 100 can include one or more sensors 162. The sensor 162 may be disposed within the aftertreatment system 100. The sensor 162 may be disposed upstream, within, around, or downstream of the catalyst system 155. The sensor 162 may be disposed upstream, within, around, or downstream of the particulate filter 116. The sensor 162 is electrically or communicatively coupled to the controller 150 and is configured to provide one or more signals associated with the exhaust and/or the fluid mixture of the exhaust and the treatment fluid to the controller 150. The sensor 162 is configured to provide a signal and the controller 150 is configured to receive the signal from the sensor 162 and determine a characteristic of the exhaust and/or the fluid mixture of the exhaust and the treatment fluid based on the signal. Each of the sensors 162 may facilitate measurement of the same characteristic or a number of characteristics of the exhaust and/or treatment fluid.

In some embodiments, the sensor 162, or at least one of the sensors 162, may be a particulate matter (PM) sensor (e.g., PM sensor probe) and the signal may be a particulate matter signal, such that the controller 150 determines a concentration of the particulate matter of the exhaust and/or the fluid mixture of the exhaust and the treatment fluid based on the particulate matter signal. The PM sensor can be configured to detect particulate matter that gets past the particulate filter 116. The PM sensor can be disposed at a location downstream of the particulate filter 116 and upstream of the decomposition chamber 118.

The sensor 162, or at least one of the sensors 162, may be a temperature sensor and the signal is a temperature signal, such that the controller 150 determines the temperature of the exhaust and/or the fluid mixture of the exhaust and the treatment fluid based on the temperature signal. The temperature of the exhaust and/or the fluid mixture of the exhaust and the treatment fluid determined by the controller 150 based on the temperature signal may represent an estimated temperature of the of the catalyst system 155. In other embodiments, the sensor 162 is a non-temperature sensor and the signal is a non-temperature signal associated with the temperature of the exhaust and/or the fluid mixture of the exhaust and the treatment fluid, such that the controller 150 determines the temperature of the exhaust and/or the fluid mixture based on the non-temperature signal. For example, the sensor 162 may be a pressure sensor and/or a velocity sensor and the signal may be a pressure signal and/or a velocity signal, and the controller 150 is configured to determine the temperature of the exhaust and/or the fluid mixture of the exhaust and the treatment fluid based on the pressure signal and/or the velocity signal.

The sensor 162, or at least one of the sensors 162, may be a nitrogen oxide sensor and the signal may be a nitrogen oxide signal, such that the controller 150 determines a concentration of the nitrogen oxide of the exhaust and/or the fluid mixture of the exhaust and the treatment fluid based on the nitrogen oxide signal. The sensor 162 can include an inlet NOₓ sensor (e.g., SCR inlet NOₓ sensor). The SCR inlet NOₓ sensor can be disposed at the inlet 156 of the catalyst system 155. The sensor 162 can include an outlet NOₓ sensor (e.g., SCR outlet NOₓ sensor). The SCR outlet NOₓ sensor can be disposed at the outlet 157 of the catalyst system 155.

### Doser Bias Detection in Aftertreatment Systems

Bias (e.g., whether the doser is underdosing or overdosing) can be detected by checking the behavior of the system during a window (e.g., time interval, window period). The behavior of the system can be checked each time when accumulated inlet NOₓ and inlet dosed NH₃ reach a threshold. Detection of bias can be based on SCR system NOₓ conversion capacity and system behavior. Bias as low as 4% can be detected using the systems and methods of the present disclosure. An estimated deNOₓ—NH₃ ratio can be evaluated over a time interval to detect bias.

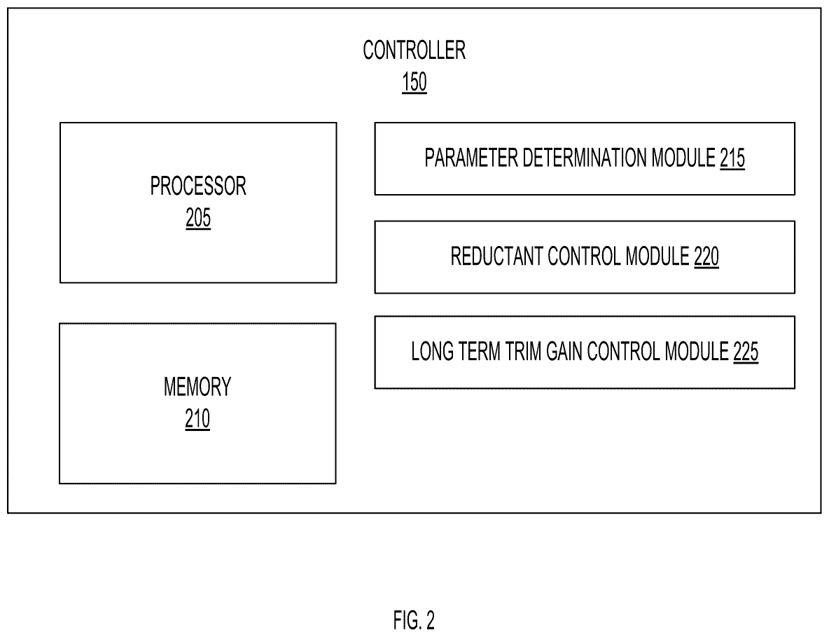

FIG. 2 illustrates a block diagram of the controller 150. The controller 150 can be configured to control an amount of reductant inserted into the decomposition chamber 118. The controller 150 can adjust the reductant injection strategy to mitigate NOₓ in emissions.

A non-transitory computer-readable medium can include computer-readable instructions stored thereon that, when executed by at least one controller 150, cause the at least one controller 150 to determine, for a time interval, an estimated deNOₓ—NH₃ ratio (e.g., catalyst NOₓ conversion capacity, estimated catalyst NOₓ conversion capacity, NOₓ conversion capacity estimated catalyst deNOₓ—NH₃ ratio). The estimated deNOₓ—NH₃ ratio can be defined by Equation 1:

$$estimated {deNO}_{x} - {NH}_{3} ratio = \frac{a c c u m u lated inlet {NO}_{x} - accumulated outlet {NO}_{x}}{injected {NH}_{3} + N {H}_{3} storage change - N {H}_{3} slip} , \qquad ( 1 )$$

where the accumulated inlet NOₓ represents an amount of NOₓ in exhaust gas at the inlet 156 of the catalyst (e.g., SCR catalyst of the catalyst system 155), the accumulated outlet NOₓ represents an amount of NOₓ in the exhaust gas at the outlet 157 of the catalyst, the injected NH₃ represents an amount of NH₃ injected into the decomposition chamber 118, the NH₃ storage change represents a change of an amount of NH₃ stored in the catalyst (e.g., the change of the amount of NH₃ during the time interval), and the NH₃ slip represents an amount of NH₃ at the outlet 146 of the aftertreatment system 100. The controller 150 can control an amount of reductant inserted into the decomposition chamber 118 based on at least the estimated deNOₓ—NH₃ ratio. The estimated deNOₓ—NH₃ ratio can indicate the catalyst NOₓ conversion capacity. The slip-based deNOₓ equation can assume that the accumulated outlet NOₓ is 0 and the outlet NOₓ sensor value is the slip NH₃ (e.g., NH₃ slip) during an NH₃ slip event.

The controller 150 can determine an overall conversion efficiency (CE) of the catalyst for the time interval. The controller 150 can determine whether the overall conversion efficiency is less than a first threshold value. The controller 150 can determine the estimated deNOₓ—NH₃ ratio in response to a determination that the overall conversion efficiency is less than the first threshold value. The controller 150 can determine a system-out NOₓ (SONOₓ) value. The controller 150 can determine whether the SONOₓ value is greater than a second threshold value. The controller 150 can determine the estimated deNOₓ—NH₃ ratio in response to a determination that the SONOₓ value is greater than the second threshold value.

The controller 150 can determine whether the estimated deNOₓ—NH₃ ratio is less than a third threshold value. The controller 150 can decrease a long-term trim gain parameter in response to a determination that the estimated deNOₓ—NH₃ ratio is less than the third threshold value. The controller 150 can determine whether the estimated deNOₓ—NH₃ ratio is greater than the third threshold value. The controller 150 can increase the long-term trim gain parameter in response to a determination that the estimated deNOₓ—NH₃ ratio is greater than the third threshold value.

In some embodiments, the time interval is a first time interval. The controller 150 can modify the long-term trim gain parameter in response to a determination that the estimated deNOₓ—NH₃ ratio is greater than or less than the third threshold value. The controller 150 can determine, for a second time interval subsequent to the first time interval, the overall conversion efficiency and the SONOₓ value. The controller 150 can determine whether the overall conversion efficiency is less than the first threshold value or whether the SONOₓ value is greater than the second threshold value. The controller 150 can reset the long-term trim gain parameter to a value before modification of the long-term trim gain parameter. For example, the controller 150 can reset the long-term trim gain parameter to a value before modification of the long-term trim gain parameter in response to a determination that, for the second time interval subsequent to the first time interval, the overall conversion efficiency is less than the first threshold value or to a determination that the SONOₓ value is greater than the second threshold value.

In some embodiments, the time interval is a first time interval. The controller 150 can determine, for a third time interval, an average of a first plurality of SONOₓ values for the aftertreatment system 100. The controller 150 can determine, for a fourth time interval, an average of a second plurality of SONOₓ values for the aftertreatment system 100. The controller 150 can determine whether the average of the first plurality of SONOₓ values is greater than a fourth threshold value. The controller 150 can determine whether the average of the second plurality of SONOₓ values is greater than the fourth threshold value. The controller 150 can determine whether NH₃ slip has occurred during the third time interval and the fourth time interval. The controller 150 can decrease the long-term trim gain parameter in response to a determination that the average of the first plurality of SONOₓ values is greater than the fourth threshold value, a determination that the average of the second plurality of SONOₓ values is greater than the fourth threshold value, and a determination that NH₃ slip has not occurred during the third time interval and the fourth time interval. When NH₃ slip has occurred during a time interval, this can be termed an “NH₃ slip event” or “ammonia slip event.”

The controller 150 can determine whether the estimated deNOₓ—NH₃ ratio is greater than the third threshold value. The controller 150 can determine whether NH₃ slip has occurred during the time interval. The controller 150 can increase the long-term trim gain parameter in response to a determination that the estimated deNOₓ—NH₃ ratio is greater than the third threshold value and a determination that NH₃ slip has occurred during the time interval.

In some embodiments, the time interval is a first time interval. The controller 150 can determine whether the estimated deNOₓ—NH₃ ratio is greater than the third threshold value. The controller 150 can determine whether NH₃ slip has occurred during a second time interval prior to the first time interval. The controller 150 can determine whether an ammonia to NOₓ (ANR) ratio is less than a fifth threshold value. The controller 150 can increase the long-term trim gain parameter in response to a determination that the estimated deNOₓ—NH₃ ratio is greater than the third threshold value, a determination that NH₃ slip has occurred during the second time interval prior to the first time interval, and a determination that the ANR ratio is less than the fifth threshold value.

The controller 150 may include a processor 205 configured to execute computer-readable instructions stored in a computer-readable memory 210. The processor 205 may be implemented in hardware, firmware, software, or any combination thereof. The processor 205 may retrieve instruction(s) from the memory 210 for execution. The memory 210 may be any of a variety of memories that may be suitable for use with the controller 150. For example, in some embodiments, the memory 210 may include Static Random Access Memory (SRAM), Dynamic Random Access Memory (DRAM), Magnetoresistive Random Access Memory (MRAM), Phase Control Memory (PCM), Resistive Random Access Memory (ReRAM), 3D XPoint memory, ferroelectric random-access memory (FeRAM), flash memory, hard disk drive memory, floppy disk memory, magnetic tape memory, optical disk memory, and/or other types of volatile, non-volatile, and semi-volatile memories that may be considered suitable.

The controller 150 may also include a parameter determination module 215, a reductant control module 220, and a long-term trim gain control module 225. Although the parameter determination module 215, the reductant control module 220, and the long-term trim gain control module 225 are shown as separate components of the controller 150, in some embodiments, at least some of those modules may be integrated together and the integrated module may perform the functions of the individual modules that have been integrated. Further, although not shown, in some embodiments, one or more of the parameter determination module 215, the reductant control module 220, and the long-term trim gain control module 225 may have respective processing unit(s) and memory unit(s) to perform their respective functions, as described herein. In other embodiments, one or more of the parameter determination module 215, the reductant control module 220, and the long-term trim gain control module 225 may use the processor 205 and the memory 210.

The parameter determination module 215 may be configured to determine one or more of the estimated deNOₓ—NH₃ ratio, the overall conversion efficiency of the catalyst, the SONOₓ value, the average of the first plurality of SONOₓ values, the average of the second plurality of SONOₓ values, the occurrence of NH₃ slip, and/or the ANR ratio.

The parameter determination module 215 may be configured to determine the estimated deNOₓ—NH₃ ratio. The estimated deNOₓ—NH₃ ratio can be defined by Equation 1. The estimated deNOₓ—NH₃ ratio can be based on one more of the following: the amount of NOₓ in exhaust gas at the inlet 156 of the catalyst (e.g., SCR catalyst of the catalyst system 155), the amount of NOₓ in the exhaust gas at the outlet 157 of the catalyst, the amount of NH₃ injected into the decomposition chamber 118, the change of the amount of NH₃ stored in the catalyst, and the amount of NH₃ at the outlet 146 of the aftertreatment system 100. The estimated deNOₓ—NH₃ ratio can indicate whether the doser is underdosing (e.g., has negative bias) or overdosing (e.g., has positive bias). The parameter determination module 215 may be configured to determine whether the estimated deNOₓ—NH₃ ratio is less than the third threshold value. The parameter determination module 215 may be configured to determine whether the estimated deNOₓ—NH₃ ratio is greater than the third threshold value.

The parameter determination module 215 may be configured to determine the overall conversion efficiency of the catalyst. For example, the parameter determination module 215 may be configured to determine the overall conversion efficiency of the catalyst for the time interval. The time interval can include the first time interval. The parameter determination module 215 may be configured to determine whether the overall conversion efficiency is less than the first threshold value. The parameter determination module 215 may be configured to determine the estimated deNOₓ—NH₃ ratio in response to a determination that the overall conversion efficiency is less than the first threshold value. The parameter determination module 215 may be configured to determine the overall conversion efficiency of the catalyst for the second time interval subsequent to the first time interval. The parameter determination module 215 may be configured to determine whether the overall conversion efficiency of the catalyst for the second time interval is less than the first threshold value.

The parameter determination module 215 may be configured to determine the SONOₓ value. The parameter determination module 215 may be configured to determine whether the SONOₓ value is greater than the second threshold value. The parameter determination module 215 may be configured to determine the estimated deNOₓ—NH₃ ratio in response to a determination that the SONOₓ value is greater than the second threshold value. The parameter determination module 215 may be configured to determine whether the SONOₓ value for the second time interval is greater than the second threshold value.

The parameter determination module 215 may be configured to determine, for the third time interval, the average of the first plurality of SONOₓ values for the aftertreatment system 100. The parameter determination module 215 may be configured to determine, for the fourth time interval, the average of the second plurality of SONOₓ values for the aftertreatment system 100. The parameter determination module 215 may be configured to determine whether the average of the first plurality of SONOₓ values is greater than the fourth threshold value. The parameter determination module 215 may be configured to determine whether the average of the second plurality of SONOₓ values is greater than the fourth threshold value.

The parameter determination module 215 may be configured to determine whether NH₃ slip has occurred during the time interval. For example, the parameter determination module 215 may be configured to determine whether NH₃ slip has occurred during the first time interval. The parameter determination module 215 may be configured to determine whether NH₃ slip has occurred during the second time interval. The second time interval can be prior to the first time interval. The parameter determination module 215 may be configured to determine whether NH₃ slip has occurred during the third time interval. The parameter determination module 215 may be configured to determine whether NH₃ slip has occurred during the fourth time interval. The parameter determination module 215 may be configured to determine whether the ANR ratio is less than the fifth threshold value.

The parameter determination module 215 may be configured to determine a time interval when accumulated inlet NOₓ is greater than a first threshold value. The parameter determination module 215 may be configured to determine a first SONOₓ value when a first NH₃ target is greater than a first NH₃ storage for the time interval. The parameter determination module 215 may be configured to determine a second SONOₓ value when a second NH₃ storage is greater than a second NH₃ target for the time interval. The parameter determination module 215 may be configured to determine a ratio between the first SONOₓ value and the second SONOₓ value. The parameter determination module 215 may be configured to determine a maximum SONOₓ value when the second NH₃ storage is greater than the second NH₃ target. The parameter determination module 215 may be configured to determine a minimum SONOₓ value when the second NH₃ storage is greater than the second NH₃ target. The parameter determination module 215 may be configured to determine a ratio between the maximum SONOₓ value and the minimum SONOₓ value.

The reductant control module 220 may be configured to control the amount of reductant inserted into the decomposition chamber 118. For example, the reductant control module 220 may be configured to control the amount of reductant inserted into the decomposition chamber 118 based on at least the estimated deNOₓ—NH₃ ratio. If the doser is underdosing, then the reductant control module 220 may be configured to increase the amount of reductant inserted into the decomposition chamber 118. If the doser overdosing, then the reductant control module 220 may be configured to decrease the amount of reductant inserted into the decomposition chamber 118. The reductant control module 220 may be configured to control the amount of reductant inserted into the decomposition chamber based on at least one of the ratio between the first SONOₓ value and the second SONOₓ value or the ratio between the maximum SONOₓ value and the minimum SONOₓ value.

The long-term trim gain control module 225 may be configured to modify a long-term trim gain parameter. For example, the long-term trim gain control module 225 may be configured to modify the long-term trim gain parameter in response to a determination that the estimated deNOₓ—NH₃ ratio is greater than or less than the third threshold value. The long-term trim gain control module 225 may be configured reset the long-term trim gain parameter to a value before modification of the long-term trim gain parameter. For example, the long-term trim gain control module 225 may be configured reset the long-term trim gain parameter to a value before modification of the long-term trim gain parameter in response to a determination that the overall conversion efficiency is less than the first threshold value for the second time interval. The long-term trim gain control module 225 may be configured reset the long-term trim gain parameter to a value before modification of the long-term trim gain parameter in response to a determination that the SONOₓ value for the second time interval is greater than the second threshold value.

The long-term trim gain control module 225 may be configured to decrease the long-term trim gain parameter in response to a determination that the estimated deNOₓ—NH₃ ratio is less than the third threshold value. The long-term trim gain control module 225 may be configured to increase the long-term trim gain parameter in response to a determination that the estimated deNOₓ—NH₃ ratio is greater than the third threshold value.

The long-term trim gain control module 225 may be configured to decrease the long-term trim gain parameter in response to a determination that the average of the first plurality of SONOₓ values is greater than the fourth threshold value, a determination that the average of the second plurality of SONOₓ values is greater than the fourth threshold value, and a determination that NH₃ slip has not occurred during the third time interval and the fourth time interval. The long-term trim gain control module 225 may be configured to increase the long-term trim gain parameter in response to a determination that the estimated deNOₓ—NH₃ ratio is greater than the third threshold value and a determination that NH₃ slip has occurred during the time interval.

The long-term trim gain control module 225 may be configured to increase the long-term trim gain parameter in response to a determination that the estimated deNOₓ—NH₃ ratio is greater than the third threshold value, a determination that NH₃ slip has occurred during the second time interval prior to the first time interval, and a determination that the ANR ratio is less than the fifth threshold value. The long-term trim gain control module 225 may be configured to increase the long-term trim gain parameter in response to a determination that the estimated deNOₓ—NH₃ ratio is greater than the third threshold value and a determination that NH₃ slip has occurred during the time interval.

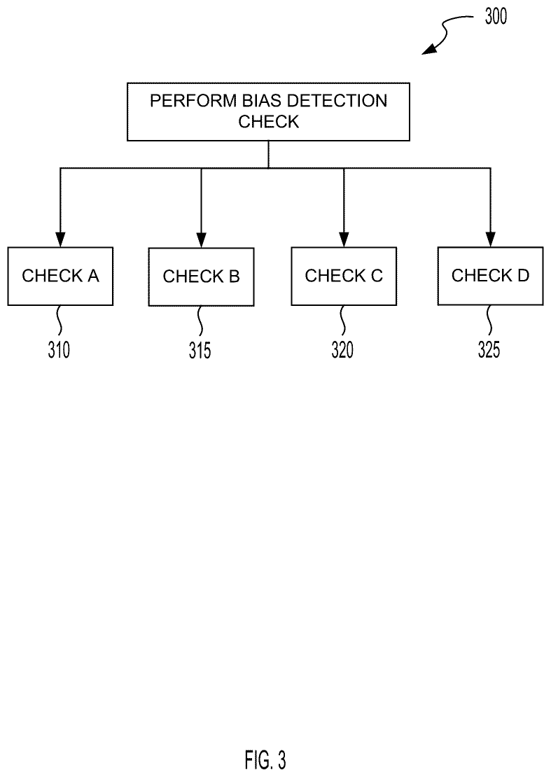

FIG. 3 illustrates a process diagram of an implementation of an exemplary process 300 (e.g., method) for performing a bias detection check (e.g., doser bias detection check). The process 300 can be implemented by any of various systems and devices described herein, including but not limited to the aftertreatment system 100 and/or the controller 150 (e.g., processor) described with reference to FIGS. 1 and 2. The process 300 can be implemented in any of various modalities, including but not limited to real-time techniques in which one or more aspects of the process 300 are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and an amount of NH₃ at the outlet 146 of the aftertreatment system 100.

The process 300 includes performing a bias detection check. The bias detection check can include at least one of Check A (310), Check B (315), Check C (320), or Check D (325). For example, the bias detection check can include performing at least one of Check A (310), Check B (315), Check C (320), or Check D (325). The bias detection check can include performing a portion of Check A (310), Check B (315), Check C (320), or Check D (325). The bias detection check can include performing Check A (310), Check B (315), Check C (320), and Check D (325) in parallel or serially. For example, the bias detection check can include performing Check A (310), Check B (315), Check C (320), and/or Check D (325) at the same time. The bias detection check can include performing Check A (310) followed by Check B (315), Check C (320), and/or Check D (325). The bias detection check can include performing Check B (315) followed by Check A (310), Check C (320), and/or Check D (325). The bias detection check can include performing Check C (320) followed by Check A (310), Check B (315), and/or Check D (325). The bias detection check can include performing Check D (325) followed by Check A (310), Check B (315), and/or Check C (320).

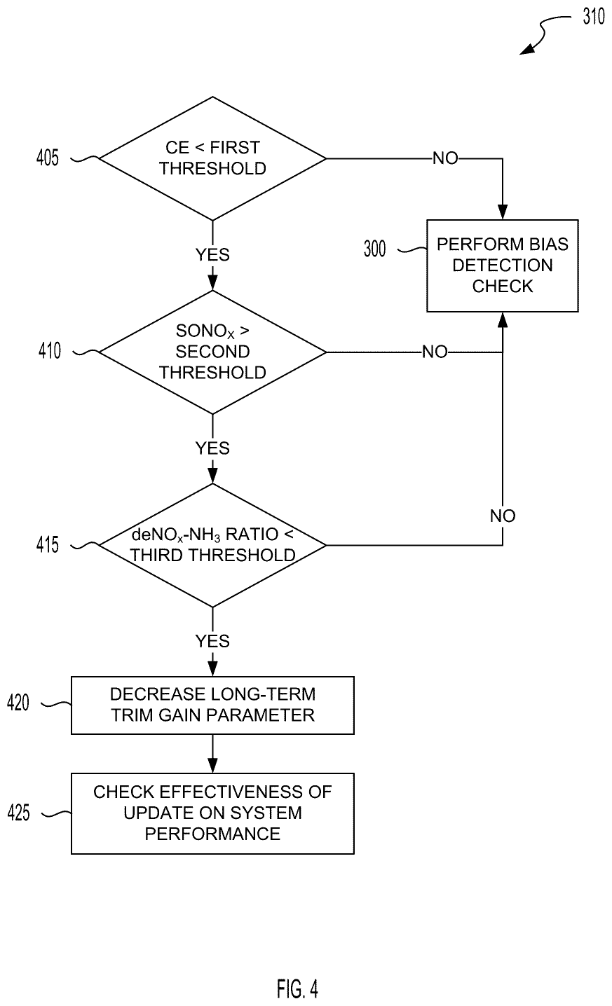

FIG. 4 illustrates a process diagram of an implementation of an exemplary process for performing Check A (310) of the bias detection check of FIG. 3. The process of performing Check A (310) can be implemented by any of various systems and devices described herein, including but not limited to the aftertreatment system 100 and/or the controller 150 (e.g., processor) described with reference to FIGS. 1 and 2. The process of performing Check A (310) can be implemented in any of various modalities, including but not limited to real-time techniques in which one or more aspects of the process of performing Check A (310) are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and/or an amount of NH₃ at the outlet 146 of the aftertreatment system 100. The process of performing Check A (310) can detect negative bias in the aftertreatment system 100 by checking conversion efficiency, inlet NOₓ (e.g., accumulated inlet NOₓ) and outlet NOₓ (e.g., accumulated outlet NOₓ) during one or more time intervals. When there is no slip in a tailpipe of the aftertreatment system 100, the estimated deNOₓ—NH₃ ratio should stay close to stoichiometric. When the aftertreatment system 100 remains in underdosing condition with NOₓ slip, the average deNOₓ—NH₃ ratio stays lower than stoichiometric ratio and aftertreatment system 100 has low average conversion efficiency. By tracking the estimated deNOₓ—NH₃ ratio when SCR accumulated CE or SONOₓ is not in a good condition, negative bias can be detected.

The process of performing Check A (310) can include determining whether the overall conversion efficiency is less than the first threshold value (405). The overall conversion efficiency can be defined by Equation 2:

$$ove rall conve rsion efficiency = \frac{a c c u m u lated inlet {NO}_{x} - accumulated outlet {NO}_{x}}{accumulated inlet {NO}_{x}} , \qquad ( 2 )$$

where the accumulated inlet NOₓ represents an amount of NOₓ in exhaust gas at the inlet 156 of the catalyst and the accumulated outlet NOₓ represents an amount of NOₓ in the exhaust gas at the outlet 157 of the catalyst.

The overall conversion efficiency can be determined (e.g., calculated) for the time interval (e.g., window). The time interval can include the first time interval. The time interval can be determined (e.g., defined) by based on at least the amount of NOₓ in exhaust gas at the inlet 156 of the catalyst or the amount of NH₃ injected into the decomposition chamber 118. For example, the sensor 162 can include the SCR inlet NOₓ sensor. The SCR inlet NOₓ sensor can take one or more measurements of the NOₓ in the exhaust gas. For example, the SCR inlet NOₓ sensor can take measurements of the NOₓ in the exhaust gas at a defined times (e.g., every 0.2 seconds). The measurements of the NOₓ in the exhaust gas at the inlet 156 of the catalyst can be added up (e.g., accumulated) to determine a value of the accumulated NOₓ at the inlet 156 of the catalyst. When the value of the accumulated NOₓ at the inlet 156 of the catalyst is equal to or greater than a first window threshold and/or the value of the amount of NH₃ injected into the decomposition chamber 118 is greater than a second window threshold, the time interval can be defined. To determine whether the aftertreatment system 100 is operating as intended, the accumulated NOₓ at the inlet 156 of the catalyst and/or the value of the amount of NH₃ injected into the decomposition chamber 118 can be used as a baseline. The accumulated NOₓ at the inlet 156 of the catalyst and/or the value of the amount of NH₃ injected into the decomposition chamber 118 can be used to evaluate the performance of the aftertreatment system 100.

The first threshold value may be a predetermined value stored in a data storage device, such as the memory 210, to be accessed when determining if the overall conversion efficiency is less than the first threshold value. The predetermined value may be an empirically determined value. The predetermined value may be indicative that the aftertreatment system 100 is underperforming. If the overall conversion efficiency is not less than the first threshold value, then the process of performing Check A (310) returns to the process 300 of performing the bias detection check. If the overall conversion efficiency is less than the first threshold value (405), then the process of performing Check A (310) continues.

The process of performing Check A (310) can include determining whether the SONOₓ value is greater than the second threshold value (410). The SONOₓ value can be determined for the time interval (e.g., the same time interval as the time interval for determining the overall conversion efficiency). The SONOₓ value can include the system-out NOₓ value. The SONOₓ value can include the amount of NOₓ in the exhaust gas at the outlet 146 of the aftertreatment system 100. The SONOₓ value can include the amount of NOₓ in the exhaust gas at the outlet 157 of the catalyst.

The second threshold value may be a predetermined value stored in a data storage device, such as the memory 210, to be accessed when determining if the SONOₓ value is greater than the second threshold value. The predetermined value may be an empirically determined value. The predetermined value may be indicative that the aftertreatment system 100 is underperforming. If the SONOₓ value is not greater than the second threshold value, then the process of performing Check A (310) returns to the process 300 of performing the bias detection check. If the SONOₓ value is greater than the second threshold value (410), then the process of performing Check A (310) continues.

The process of performing Check A (310) can include determining whether the average estimated deNOₓ—NH₃ ratio in a plurality of time intervals is less than the third threshold value (415). The estimated deNOₓ—NH₃ ratio can be defined by Equation 1. The estimated deNOₓ—NH₃ ratio can be a function of one or more of the amount of NOₓ in exhaust gas at the inlet 156 of the catalyst, the amount of NOₓ in the exhaust gas at the outlet 157 of the catalyst, the amount of NH₃ injected into the decomposition chamber 118, the change of the amount of NH₃ stored in the catalyst, and the amount of NH₃ at the outlet 146 of the aftertreatment system 100. The estimated deNOₓ—NH₃ ratio can be determined in response to the determination that the overall conversion capacity is less than the first threshold value. The estimated deNOₓ—NH₃ ratio can be determined in response to the determination that the SONOₓ value is greater than the second threshold value. The estimated deNOₓ—NH₃ ratio can be determined for the time interval (e.g., first time interval). The average estimated deNOₓ—NH₃ ratio can be determined for the plurality of time intervals.

The third threshold value may be a predetermined value stored in a data storage device, such as the memory 210, to be accessed when determining if the estimated deNOₓ—NH₃ ratio is less than the third threshold value. The predetermined value may be an empirically determined value. The predetermined value may be indicative that the doser is underdosing reductant. If the estimated deNOₓ—NH₃ ratio is not less than the third threshold value, then the process of performing Check A (310) returns to the process 300 of performing the bias detection check. If the estimated deNOₓ—NH₃ ratio is less than the third threshold value (415), then the process of performing Check A (310) continues.

The process of performing Check A (310) can include decreasing the long-term trim gain parameter (420). Updating (e.g., modifying) the long-term trim gain parameter can include decreasing the long-term trim gain (e.g., LLT, LTT gain) parameter. The long-term trim can characterize deviations of air-to-fuel stoichiometry. For example, the long-term trim can characterize deviations of air-to-fuel stoichiometry in the engine 101 due to the engine's current operating conditions. The long-term trim gain parameter can be decreased in response to the determination that the estimated deNOₓ—NH₃ ratio is less than the third threshold value.

The process of performing Check A (310) can include checking the effectiveness of the update on the performance of the aftertreatment system (425). For example, the effectiveness of the decrease of the long-term trim gain parameter on the performance of the aftertreatment system 100 can be checked (e.g., evaluated). The performance of the aftertreatment system 100 can be checked by determining the overall conversion efficiency and/or SONOₓ value. For example, the overall conversion efficiency can be determined for (e.g., during) the second time interval. The second time interval can be subsequent to the first time interval. The performance of the aftertreatment system 100 can be checked by determining whether the overall conversion efficiency is less than the first threshold value or whether the SONOₓ value is greater than the second threshold value. For example, the performance of the aftertreatment system 100 can be checked by determining whether the overall conversion efficiency for the second time interval is less than the first threshold value. The performance of the aftertreatment system 100 can be checked by determining whether the SONOₓ value for the second time interval is greater than the second threshold value.

If the performance of the aftertreatment system does not improve after decreasing the long-term trim gain parameter, then the long-term trim gain parameter can be reset. For example, the long-term trim gain parameter can be reset to the value before modification of the long-term trim gain parameter. For example, the long-term trim gain parameter can be reset to the value before modification of the long-term trim gain parameter in response to the determination that the overall conversion efficiency, for the second time interval subsequent to the first time interval, is less than the first threshold value. The long-term trim gain parameter can be reset to the value before modification of the long-term trim gain parameter in response to the determination that the SONOₓ value is greater than the second threshold value.

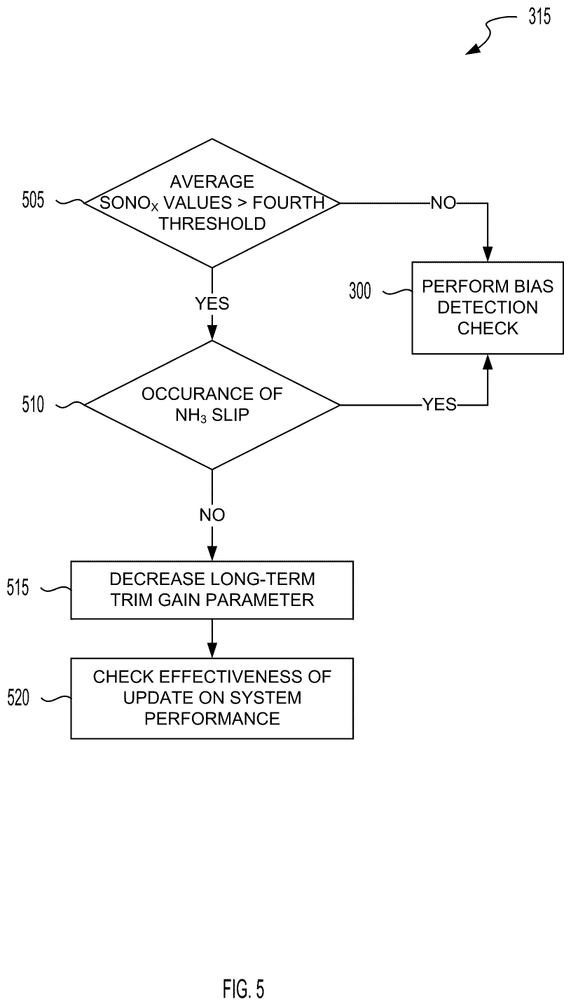

FIG. 5 illustrates a process diagram of an implementation of an exemplary process for performing Check B (315) of the bias detection check of FIG. 3. The process of performing Check B (315) can be implemented by any of various systems and devices described herein, including but not limited to the aftertreatment system 100 and/or the controller 150 (e.g., processor) described with reference to FIGS. 1 and 2. The process of performing Check B (315) can be implemented in any of various modalities, including but not limited to real-time techniques in which one or more aspects of the process of performing Check B (315) are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and/or an amount of NH₃ at the outlet 146 of the aftertreatment system 100. The process of performing Check B (315) can detect negative bias in the aftertreatment system 100 by checking the average of accumulated system-out NOₓ. If the accumulated SONOₓ has a high value in multiple windows when there is no NH₃ slip detected, this can indicate there is negative bias in the aftertreatment system 100 which causes the controller 150 to be stuck in an NOₓ slip condition.

The process of performing Check B (315) can include determining whether the average of a plurality of SONOₓ values is greater than the fourth threshold value (505). The average of the plurality of SONOₓ values can be determined based on average of the plurality of SONOₓ values in a plurality of windows (e.g., time intervals, multiple windows). The plurality of SONOₓ values can include the first plurality of SONOₓ values. The average of the first plurality of SONOₓ values for the aftertreatment system 100 can be determined for the third time interval. The plurality of SONOₓ values can include the second plurality of SONOₓ values. The average of the second plurality of SONOₓ values for the aftertreatment system 100 can be determined for the fourth time interval. The fourth time interval can be different from the third time interval.

The fourth threshold value may be a predetermined value stored in a data storage device, such as the memory 210, to be accessed when determining if the average of the first plurality of SONOₓ values is greater than the fourth threshold value or if the average of the second plurality of SONOₓ values is greater than the fourth threshold value. The predetermined value may be an empirically determined value. The predetermined value may be indicative that the aftertreatment system 100 is underperforming. If the average of the first plurality of SONOₓ values is not greater than the fourth threshold value, then the process of performing Check B (315) returns to the process 300 of performing the bias detection check. If the average of the second plurality of SONOₓ values is not greater than the fourth threshold value, then the process of performing Check B (315) returns to the process 300 of performing the bias detection check. If the average of the first plurality of SONOₓ values is greater than the fourth threshold value and the average of the second plurality of SONOₓ values is greater than the fourth threshold value (505), then the process of performing Check B (315) continues.

The process of performing Check B (315) can include determining whether NH₃ slip has occurred (510). For example, the process can include determining whether NH₃ slip (e.g., ammonia slip) has occurred during the third time interval. The process can include determining whether NH₃ slip has occurred during the fourth time interval. NH₃ slip can include slipping NH₃ at an outlet of the aftertreatment system. NH₃ slip can include unreacted ammonia at the outlet of the aftertreatment system. If NH₃ slip has occurred during the third time interval, then the process of performing Check B (315) returns to the process 300 of performing the bias detection check. If NH₃ slip has occurred during the fourth time interval, then the process of performing Check B (315) returns to the process 300 of performing the bias detection check. If NH₃ slip has not occurred during the third time interval and the fourth time interval (510), then the process of performing Check B (315) continues.

The process of performing Check B (315) can include decreasing the long-term trim gain parameter (515). Updating the long-term trim gain parameter can include decreasing the long-term trim gain parameter. The long-term trim gain parameter can be decreased in response to the determination that the average of the first plurality of SONOₓ values is greater than the fourth threshold value, the determination that the average of the second plurality of SONOₓ values is greater than the fourth threshold value, and the determination that NH₃ slip has not occurred during the third time interval and the fourth time interval.

The process of performing Check B (315) can include checking the effectiveness of the update on the performance of the aftertreatment system (520). For example, the effectiveness of the decrease of the long-term trim gain parameter on the performance of the aftertreatment system 100 can be checked. The performance of the aftertreatment system 100 can be checked by determining the overall conversion efficiency and/or SONOₓ value. For example, the overall conversion efficiency can be determined for (e.g., during) a fifth time interval subsequent to the third time interval and the fourth time interval. The SONOₓ value can be determined for the fifth time interval. The performance of the aftertreatment system 100 can be checked by determining whether the overall conversion efficiency is less than the first threshold value or whether the SONOₓ value is greater than the second threshold value. For example, the performance of the aftertreatment system 100 can be checked by determining whether the overall conversion efficiency for the fifth time interval is less than the first threshold value. The performance of the aftertreatment system 100 can be checked by determining whether the SONOₓ value for the fifth time interval is greater than the second threshold value.

If the performance of the aftertreatment system does not improve after decreasing the long-term trim gain parameter, then the long-term trim gain parameter can be reset. For example, the long-term trim gain parameter can be reset to a value before modification of the long-term trim gain parameter. For example, the long-term trim gain parameter can be reset to a value before modification of the long-term trim gain parameter in response to the determination that the average of the first plurality of SONOₓ values is greater than the fourth threshold value, the determination that the average of the second plurality of SONOₓ values is greater than the fourth threshold value, and the determination that NH₃ slip has not occurred during the third time interval and the fourth time interval.

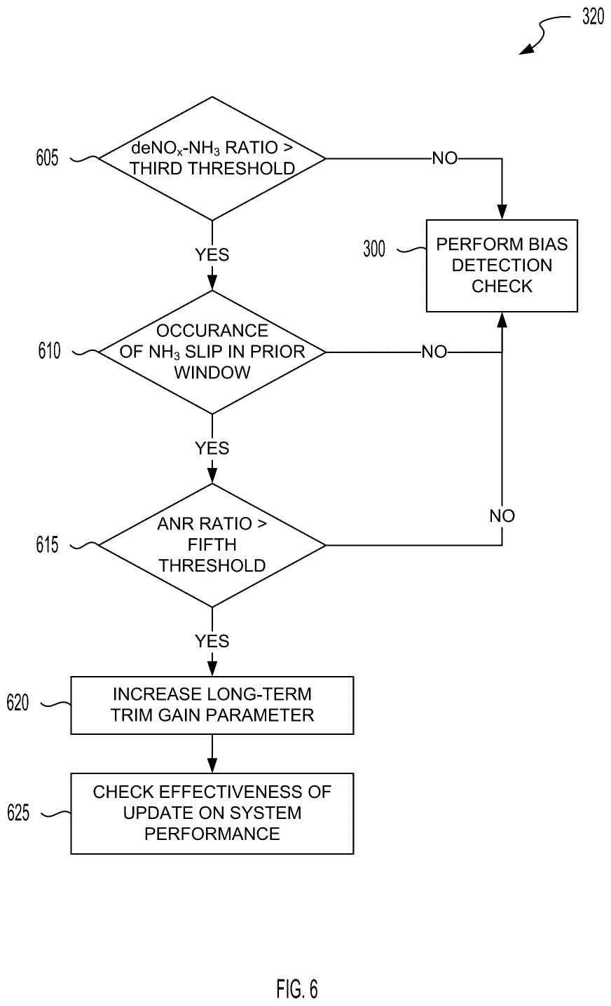

FIG. 6 illustrates a process diagram of an implementation of an exemplary process for performing Check C (320) of the bias detection check of FIG. 3. The process of performing Check C (320) can be implemented by any of various systems and devices described herein, including but not limited to the aftertreatment system 100 and/or the controller 150 (e.g., processor) described with reference to FIGS. 1 and 2. The process of performing Check C (320) can be implemented in any of various modalities, including but not limited to real-time techniques in which one or more aspects of the process of performing Check C (320) are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and/or an amount of NH₃ at the outlet 146 of the aftertreatment system 100. The process of performing Check C (320) can detect positive bias in the aftertreatment system 100 by checking the estimated deNOₓ—NH₃ ratio when controller 150 is mostly operating in storage reference control mode without significant slip in the tailpipe. If the controller 150 operates with a high deNOₓ—NH₃ ratio and a low ANR, and NH₃ slip is detected previously during operation, this indicates there is positive bias in the aftertreatment system 100.

The process of performing Check C (320) can include determining whether the estimated deNOₓ—NH₃ ratio is greater than the third threshold value (605). The estimated deNOₓ—NH₃ ratio can be defined by Equation 1. The estimated deNOₓ—NH₃ ratio can be a function of one or more of the amount of NOₓ in exhaust gas at the inlet 156 of the catalyst, the amount of NOₓ in the exhaust gas at the outlet 157 of the catalyst, the amount of NH₃ injected into the decomposition chamber 118, the change of the amount of NH₃ stored in the catalyst, and the amount of NH₃ at the outlet 146 of the aftertreatment system 100. The estimated deNOₓ—NH₃ ratio can be determined for the time interval (e.g., first time interval).

The third threshold value may be a predetermined value stored in a data storage device, such as the memory 210, to be accessed when determining if the estimated deNOₓ—NH₃ ratio is greater than the third threshold value. The predetermined value may be an empirically determined value. The predetermined value may be indicative that the doser is overdosing reductant. If the estimated deNOₓ—NH₃ ratio is not greater than the third threshold value, then the process of performing Check C (320) returns to the process 300 of performing the bias detection check. If the estimated deNOₓ—NH₃ ratio is greater than the third threshold value (605), then the process of performing Check C (320) continues.

The process of performing Check C (320) can include determining whether NH₃ slip has occurred (610). For example, the process can include determining whether NH₃ slip has occurred during a second time interval. The second time interval can be prior to the first time interval. If NH₃ slip has not occurred during the prior time interval, then the process of performing Check C (320) returns to the process 300 of performing the bias detection check. If NH₃ slip has occurred during the time interval (610), then the process of performing Check C (320) continues.

The process of performing Check C (320) can include determining whether the ammonia to NOₓ ratio is greater than the fifth threshold value (615). The ammonia to NOₓ ratio can be defined as a ratio of ammonia to NOₓ. The ammonia to NOₓ ratio can be determined for the time interval (e.g., first time interval).

The fifth threshold value may be a predetermined value stored in a data storage device, such as the memory 210, to be accessed when determining if the ammonia to NOₓ ratio is greater than the fifth threshold value. The predetermined value may be an empirically determined value. The predetermined value may be indicative that the doser is overdosing. If the ammonia to NOₓ ratio is not greater than the fifth threshold value, then the process of performing Check C (320) returns to the process 300 of performing the bias detection check. If the ammonia to NOₓ ratio is greater than the fifth threshold value (615), then the process of performing Check C (320) continues.

The process of performing Check C (320) can include increasing the long-term trim gain parameter (620). Updating the long-term trim gain parameter can include increasing the long-term trim gain parameter. The long-term trim gain parameter can be increased in response to the determination that the estimated deNOₓ—NH₃ ratio is greater than the third threshold value, the determination that NH₃ slip has occurred during the second time interval prior to the first time interval, and the determination that the ANR ratio is less than the fifth threshold value.

The process of performing Check C (320) can include checking the effectiveness of the update on the performance of the aftertreatment system (625). For example, the effectiveness of the increase of the long-term trim gain parameter on the performance of the aftertreatment system 100 can be checked. The performance of the aftertreatment system 100 can be checked by determining the overall conversion efficiency and/or SONOₓ value. For example, the overall conversion efficiency can be determined for (e.g., during) a third time interval. The third time interval can be subsequent to the first time interval. The performance of the aftertreatment system 100 can be checked by determining whether the overall conversion efficiency is less than the first threshold value or whether the SONOₓ value is greater than the second threshold value. For example, the performance of the aftertreatment system 100 can be checked by determining whether the overall conversion efficiency for the third time interval is less than the first threshold value. The performance of the aftertreatment system 100 can be checked by determining whether the SONOₓ value for the third time interval is greater than the second threshold value.

If the performance of the aftertreatment system does not improve after increasing the long-term trim gain parameter, then the long-term trim gain parameter can be reset. For example, the long-term trim gain parameter can be reset to the value before modification of the long-term trim gain parameter. For example, the long-term trim gain parameter can be reset to the value before modification of the long-term trim gain parameter in response to the determination that the overall conversion efficiency, for the third time interval subsequent to the first time interval, is less than the first threshold value. The long-term trim gain parameter can be reset to the value before modification of the long-term trim gain parameter in response to the determination that the SONOₓ value is greater than the second threshold value.

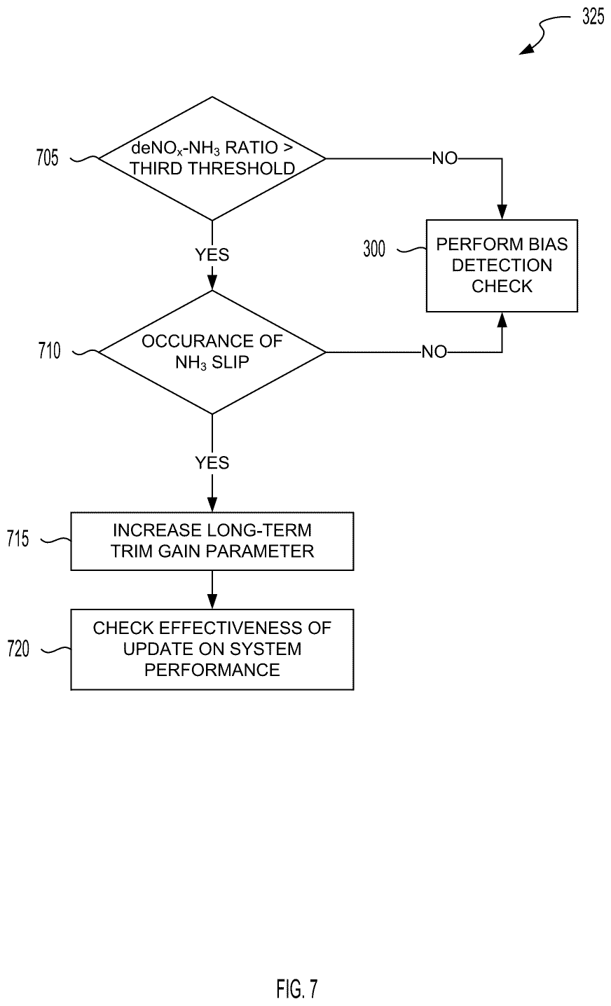

FIG. 7 illustrates a process diagram of an implementation of an exemplary process for performing Check D (325) of the bias detection check of FIG. 3. The process of performing Check D (325) can be implemented by any of various systems and devices described herein, including but not limited to the aftertreatment system 100 and/or the controller 150 (e.g., processor) described with reference to FIGS. 1 and 2. The process of performing Check D (325) can be implemented in any of various modalities, including but not limited to real-time techniques in which one or more aspects of the process of performing Check D (325) are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and/or an amount of NH₃ at the outlet 146 of the aftertreatment system 100. The process of performing Check D (325) can detect positive bias in the aftertreatment system 100 by checking the estimated deNOₓ—NH₃ ratio when NH₃ slip is detected in the current checking window. If the controller 150 operates with high slip-based ratio, this indicates there is positive bias in the aftertreatment system 100.

The process of performing Check D (325) can include determining whether the estimated deNOₓ—NH₃ ratio is greater than the third threshold value (705). The estimated deNOₓ—NH₃ ratio can be defined by Equation 1. The estimated deNOₓ—NH₃ ratio can be a function of one or more of the amount of NOₓ in exhaust gas at the inlet 156 of the catalyst, the amount of NOₓ in the exhaust gas at the outlet 157 of the catalyst, the amount of NH₃ injected into the decomposition chamber 118, the change of the amount of NH₃ stored in the catalyst, and the amount of NH₃ at the outlet 146 of the aftertreatment system 100. The estimated deNOₓ—NH₃ ratio can be determined for the time interval (e.g., first time interval).

The third threshold value may be a predetermined value stored in a data storage device, such as the memory 210, to be accessed when determining if the estimated deNOₓ—NH₃ ratio is greater than the third threshold value. The predetermined value may be an empirically determined value. The predetermined value may be indicative that the doser is overdosing. If the estimated deNOₓ—NH₃ ratio is not greater than the third threshold value, then the process of performing Check D (325) returns to the process 300 of performing the bias detection check. If the estimated deNOₓ—NH₃ ratio is greater than the third threshold value (705), then the process of performing Check D (325) continues.

The process of performing Check D (325) can include determining whether NH₃ slip has occurred (710). For example, the process can include determining whether NH₃ slip has occurred during the time interval. If NH₃ slip has not occurred during the time interval, then the process of performing Check D (325) returns to the process 300 of performing the bias detection check. If NH₃ slip has occurred during the time interval (710), then the process of performing Check D (325) continues.

The process of performing Check D (325) can include increasing the long-term trim gain parameter (715). Updating the long-term trim gain parameter can include increasing the long-term trim gain parameter. The long-term trim gain parameter can be increased in response to the determination that the estimated deNOₓ—NH₃ ratio is greater than the third threshold value and the determination that NH₃ slip has occurred during the time interval.

The process of performing Check D (325) can include checking the effectiveness of the update on the performance of the aftertreatment system (720). For example, the effectiveness of the increase of the long-term trim gain parameter on the performance of the aftertreatment system 100 can be checked. The performance of the aftertreatment system 100 can be checked by determining the overall conversion efficiency and/or SONOₓ value. For example, the overall conversion efficiency can be determined for (e.g., during) the second time interval. The second time interval can be subsequent to the first time interval. The performance of the aftertreatment system 100 can be checked by determining whether the overall conversion efficiency is less than the first threshold value or whether the SONOₓ value is greater than the second threshold value. For example, the performance of the aftertreatment system 100 can be checked by determining whether the overall conversion efficiency for the second time interval is less than the first threshold value. The performance of the aftertreatment system 100 can be checked by determining whether the SONOₓ value for the second time interval is greater than the second threshold value.

If the performance of the aftertreatment system does not improve after increasing the long-term trim gain parameter, then the long-term trim gain parameter can be reset. For example, the long-term trim gain parameter can be reset to the value before modification of the long-term trim gain parameter. For example, the long-term trim gain parameter can be reset to the value before modification of the long-term trim gain parameter in response to the determination that the overall conversion efficiency, for the second time interval subsequent to the first time interval, is less than the first threshold value. The long-term trim gain parameter can be reset to the value before modification of the long-term trim gain parameter in response to the determination that the SONOₓ value is greater than the second threshold value.

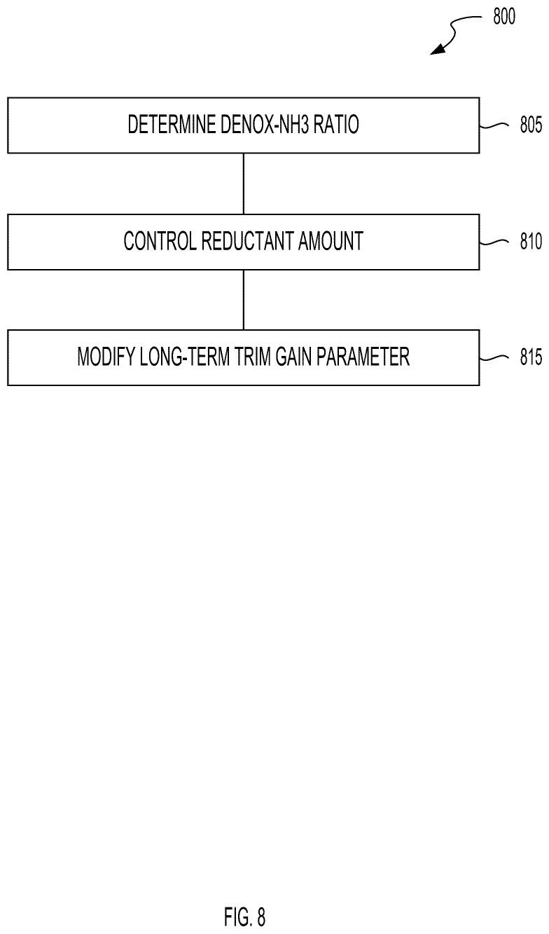

FIG. 8 illustrates a block diagram of an implementation of an exemplary process 800 for controlling an amount of reductant inserted into the decomposition chamber 118 of the aftertreatment system 100. The process 800 can be implemented by any of various systems and devices described herein, including but not limited to the aftertreatment system 100 and/or the controller 150 (e.g., processor) described with reference to FIGS. 1 and 2. The process 800 can be implemented in any of various modalities, including but not limited to real-time techniques in which one or more aspects of the process 800 are executed responsive to real-time sensor data detected regarding an amount of NOₓ in exhaust gas at the inlet 156 of the catalyst, an amount of NOₓ in the exhaust gas at the outlet 157 of the catalyst, an amount of NH₃ injected into the decomposition chamber 118, a change of an amount of NH₃ stored in the catalyst, and an amount of NH₃ at the outlet 146 of the aftertreatment system 100. The process 800 can include large bias detection. Large bias detection can include checking the system behavior during one or more time intervals (e.g., windows). The windows can be defined based on accumulated dosing and accumulated inlet NOₓ.

The process 800 can include determining a conversion capacity (805). The conversion capacity can include the estimated deNOₓ—NH₃ ratio. The estimated deNOₓ—NH₃ ratio can be defined by Equation 1. The estimated deNOₓ—NH₃ ratio can be a function of one or more of the amount of NOₓ in exhaust gas at the inlet 156 of the catalyst, the amount of NOₓ in the exhaust gas at the outlet 157 of the catalyst, the amount of NH₃ injected into the decomposition chamber 118, the change of the amount of NH₃ stored in the catalyst, and the amount of NH₃ at the outlet 146 of the aftertreatment system 100. The estimated deNOₓ—NH₃ ratio can be determined for the time interval (e.g., first time interval).

The process 800 can include controlling an amount of reductant (810). For example, the process 800 can include controlling the amount of reductant inserted into the decomposition chamber 118 based on at least the estimated deNOₓ—NH₃ ratio. The amount of reductant inserted into the decomposition chamber 118 can be controlled based on the determination that the estimated deNOₓ—NH₃ ratio is less than the third threshold value. The amount of reductant inserted into the decomposition chamber 118 can be controlled based on the determination that the estimated deNOₓ—NH₃ ratio is greater than the third threshold value.

The process 800 can include modifying a long-term trim gain parameter (815). For example, modifying the long-term trim gain parameter can include decreasing the long-term trim gain parameter. The long-term trim gain parameter can be decreased in response to the determination that the estimated deNOₓ—NH₃ ratio is less than the third threshold value. Modifying the long-term trim gain parameter can include increasing the long-term trim gain parameter. The long-term trim gain parameter can be increased in response to the determination that the estimated deNOₓ—NH₃ ratio is greater than the third threshold value.

The process 800 can include determining the overall conversion efficiency of the catalyst for the time interval. The process 800 can include determining whether the overall conversion efficiency is less than the first threshold value. The process 800 can include determining the estimated deNOₓ—NH₃ ratio in response to the determination that the overall conversion efficiency is less than the first threshold value.

The process 800 can include determining the SONOₓ value. The process 800 can include determining whether the SONOₓ value is greater than the second threshold value. The process 800 can include determining the estimated deNOₓ—NH₃ ratio in response to the determination that the SONOₓ value is greater than the second threshold value.

In some embodiments, the time interval is the first time interval. The process 800 can include modifying the long-term trim gain parameter in response to the determination that the estimated deNOₓ—NH₃ ratio is greater than or less than the third threshold value. The process 800 can include determining, for the second time interval subsequent to the first time interval, an overall conversion efficiency and a SONOₓ value. The process 800 can include determining whether the overall conversion efficiency is less than the first threshold value or whether the SONOₓ value is greater than the second threshold value, The process 800 can include resetting the long-term trim gain parameter to the value before modification of the long-term trim gain parameter in response to the determination that the overall conversion efficiency is less than the first threshold value or to the determination that the SONOₓ value is greater than the second threshold value.

In some embodiments, the time interval is the first time interval. The process 800 can include determining, for the third time interval, the average of the first plurality of SONOₓ values for the aftertreatment system. The process 800 can include determining, for the fourth time interval, the average of the second plurality of SONOₓ values for the aftertreatment system. The process 800 can include determining whether the average of the first plurality of SONOₓ values is greater than a fourth threshold value. The process 800 can include determining whether the average of the second plurality of SONOₓ values is greater than the fourth threshold value. The process 800 can include determining whether NH₃ slip has occurred during the third time interval and the fourth time interval. The process 800 can include decreasing the long-term trim gain parameter in response to the determination that the average of the first plurality of SONOₓ values is greater than the fourth threshold value, the determination that the average of the second plurality of SONOₓ values is greater than the fourth threshold value, and the determination that NH₃ slip has not occurred during the third time interval and the fourth time interval.

The process 800 can include determining whether the estimated deNOₓ—NH₃ ratio is greater than the third threshold value. The process 800 can include determining whether NH₃ slip has occurred during the time interval. The process 800 can include increasing the long-term trim gain parameter in response to the determination that the estimated deNOₓ—NH₃ ratio is greater than the third threshold value and the determination that NH₃ slip has occurred during the time interval.

In some embodiments, the time interval is the first time interval. The process 800 can include determining whether the estimated deNOₓ—NH₃ ratio is greater than the third threshold value. The process 800 can include determining whether NH₃ slip has occurred during the second time interval prior to the first time interval. The process 800 can include determining the ammonia to NOₓ ratio is greater than the fifth threshold value. The process 800 can include increasing the long-term trim gain parameter in response to the determination that the estimated deNOₓ—NH₃ ratio is greater than the third threshold value, the determination that NH₃ slip has occurred during the second time interval prior to the first time interval, and the determination that the ANR ratio is less than the fifth threshold value.

The process 800 can include determining whether the estimated deNOₓ—NH₃ ratio is greater than the third threshold value. The process 800 can include determining whether NH₃ slip has occurred during the time interval. The process 800 can include determining increasing the long-term trim gain parameter in response to the determination that the estimated deNOₓ—NH₃ ratio is greater than the third threshold value and the determination that NH₃ slip has occurred during the time interval.

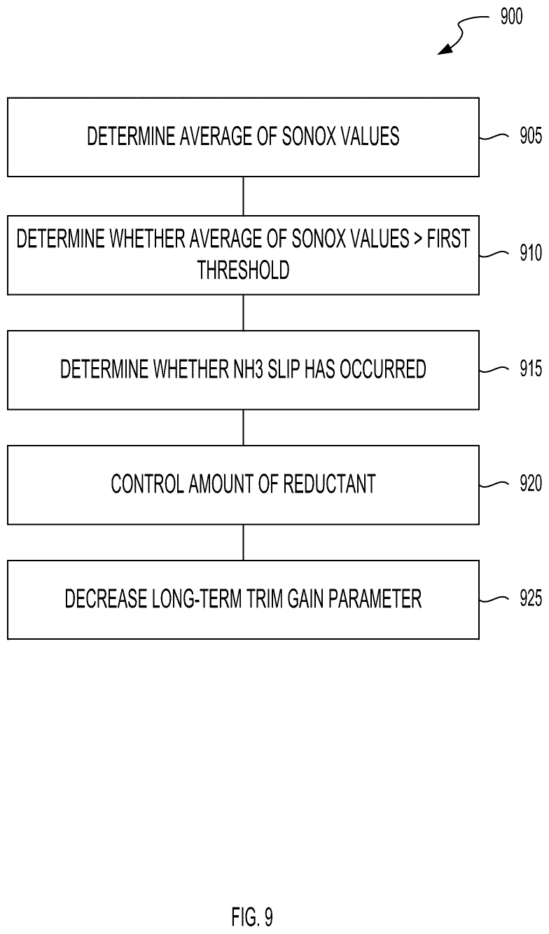

FIG. 9 illustrates a block diagram of an implementation of an exemplary process 900 for controlling an amount of reductant inserted into the decomposition chamber 118 of the aftertreatment system 100. The process 900 can be implemented by any of various systems and devices described herein, including but not limited to the aftertreatment system 100 and/or the controller 150 (e.g., processor) described with reference to FIGS. 1 and 2. The process 900 can be implemented in any of various modalities, including but not limited to real-time techniques in which one or more aspects of the process 900 are executed responsive to real-time sensor data detected regarding an amount of NOₓ an amount of NOₓ in the exhaust gas at the outlet 146 of the aftertreatment system 100 and an amount of NOₓ in the exhaust gas at the outlet 157 of the catalyst.

The process 900 can include determining an average of SONOₓ values (905). For example, the process 900 can include determining an average of a first plurality of SONOₓ values for the aftertreatment system 100. The aftertreatment system 100 can include the catalyst. The catalyst can be part of the catalyst system 155. The aftertreatment system 100 can include the decomposition chamber 118. The decomposition chamber 118 can be upstream of the catalyst. The process 900 can include determining the average of the first plurality of SONOₓ values for a first time interval. The process 900 can include determining an average of a second plurality of SONOₓ values for the aftertreatment system 100. The process 900 can include determining the average of the second plurality of SONOₓ values for a second time interval. The second time interval can be different from the first time interval.

The process 900 can include determining whether the average of the SONOₓ values is greater than a first threshold (910). For example, the process 900 can include determining whether the average of the first plurality of SONOₓ values is greater than the first threshold value. The process 900 can include determining whether the average of the second plurality of SONOₓ values is greater than the first threshold value.

The process 900 can include determining whether NH₃ slip has occurred (915). For example, the process 900 can include determining whether NH₃ slip has occurred during the first time interval. The process 900 can include determining whether NH₃ slip has occurred during the second time interval.

The process 900 can include controlling an amount of reductant (920). For example, the process 900 can include controlling the amount of reductant inserted into the decomposition chamber 118 based on at least the determination that the average of the first plurality of SONOₓ values is greater than the first threshold value, the determination that the average of the second plurality of SONOₓ values is greater than the first threshold value, and the determination that NH₃ slip has not occurred during the first time interval and the second time interval.

The process 900 can include decreasing the long-term trim gain parameter (925). The long-term trim gain parameter can be decreased in response to a determination that the average of the first plurality of SONOₓ values is greater than the first threshold value, the determination that the average of the second plurality of SONOₓ values is greater than the first threshold value, and the determination that NH₃ slip has not occurred during the first time interval and the second time interval.

The process 900 can include decreasing the long-term trim gain parameter in response to the determination that the average of the first plurality of SONOₓ values is greater than the first threshold value, the determination that the average of the second plurality of SONOₓ values is greater than the first threshold value, and the determination that NH₃ slip has not occurred during the first time interval and the second time interval.

The process 900 can include determining, for a third time interval subsequent to the first time interval and the second time interval, the overall conversion efficiency and the SONOₓ value. The process 900 can include determining whether the overall conversion efficiency is less than a second threshold value or whether the SONOₓ value is greater than a third threshold value. The process 900 can include resetting the long-term trim gain parameter to a value before decrement of the long-term trim gain parameter in response to a determination that the overall conversion efficiency is less than the second threshold value or to a determination that the SONOₓ value is greater than the third threshold value.

The process 900 can include determining the estimated deNOₓ—NH₃ ratio. The estimated deNOₓ—NH₃ ratio can be defined by Equation 1. The process 900 can include controlling the amount of reductant inserted into the decomposition chamber 118 based on at least the estimated deNOₓ—NH₃ ratio.

The process 900 can include determining whether the estimated deNOₓ—NH₃ ratio is less than the second threshold value. The process 900 can include decreasing the long-term trim gain parameter in response to a determination that the estimated deNOₓ—NH₃ ratio is less than the second threshold value.

The process 900 can include determining whether the estimated deNOₓ—NH₃ ratio is greater than the second threshold value. The process 900 can include increasing the long-term trim gain parameter in response to a determination that the estimated deNOₓ—NH₃ ratio is greater than the second threshold value.

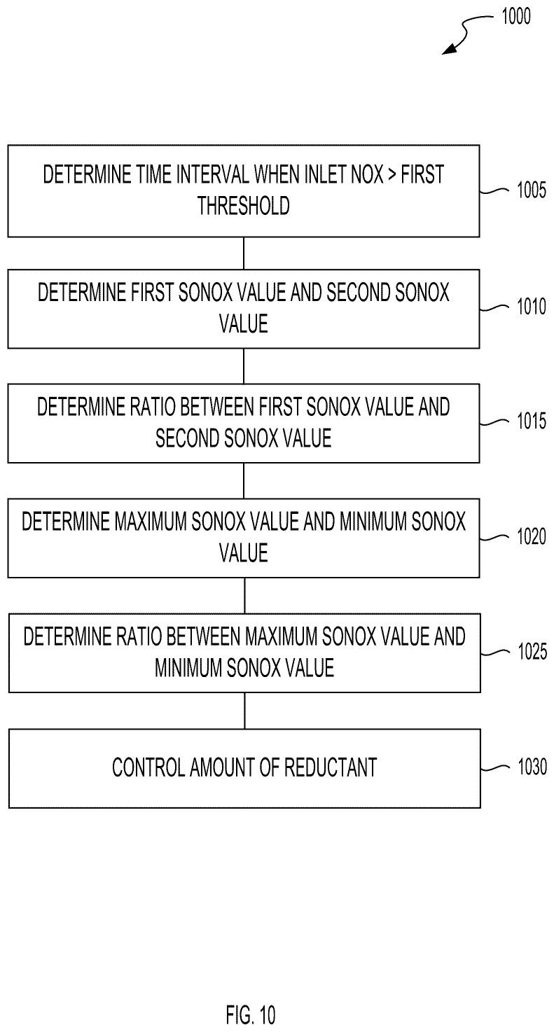

FIG. 10 illustrates a block diagram of an implementation of an exemplary process 1000 for controlling an amount of reductant inserted into the decomposition chamber 118 of the aftertreatment system 100. The process 1000 can be implemented by any of various systems and devices described herein, including but not limited to the aftertreatment system 100 and/or the controller 150 (e.g., processor) described with reference to FIGS. 1 and 2. The process 1000 can be implemented in any of various modalities, including but not limited to real-time techniques in which one or more aspects of the process 1000 are executed responsive to real-time sensor data detected regarding an amount of NOₓ an amount of NOₓ in the exhaust gas at the outlet 146 of the aftertreatment system 100 and an amount of NOₓ in the exhaust gas at the outlet 157 of the catalyst. The process 1000 can relate to small bias detection. Small bias detection include a window-based feature which detects bias each time accumulated SCR inlet NOₓ reaches a threshold. The detection can be based on the ratio of SCR outlet NOₓ before and after the transient of actual NH₃ storage amount equaling target NH₃ storage amount. Positive and/or negative bias can be detected through NOₓ sensor readings, target storage, and actual storage. If the ratio between system-out NOₓ at high actual storage and target storage is high, this can indicate negative bias. If significant system-out NOₓ appears at high storage, this can indicate positive bias.

The process 1000 can include determining a time interval when inlet NOₓ is greater than a first threshold (1005). For example, the process 1000 can include determining the time interval when accumulated inlet NOₓ is greater than the first threshold value. The SCR inlet NOₓ sensor can take one or more measurements of the NOₓ in the exhaust gas. For example, the SCR inlet NOₓ sensor can take measurements of the NOₓ in the exhaust gas at a defined times (e.g., every 0.2 seconds). The measurements of the NOₓ in the exhaust gas at the inlet 156 of the catalyst can be added up (e.g., accumulated) to determine a value of the accumulated NOₓ (e.g., accumulative NOₓ, accumulated inlet NOₓ, accumulated SCR inlet NOₓ accumulative inlet NOₓ) at the inlet 156 of the catalyst. When the value of the accumulative NOₓ at the inlet 156 of the catalyst is equal to or greater than the first threshold the time interval can be defined (e.g., determined).

The process 1000 can include determining a first SONOₓ value and a second SONOₓ value (1010). For example, the process 1000 can include determining the first SONOₓ value when a first NH₃ target is greater than a first NH₃ storage for the time interval. The NH₃ target can include a target amount of NH₃ to be stored in the catalyst. The NH₃ storage can include an actual amount or estimated amount of NH₃ stored in the catalyst. The process 1000 can include determining a second SONOₓ value when a second NH₃ storage is greater than a second NH₃ target for the time interval.

The process 1000 can include determining a ratio between the first SONOₓ value and the second SONOₓ value (1015). The ratio can include the ratio between (1) the first SONOₓ value when the first NH₃ target is greater than the first NH₃ storage for the time interval and (2) the second SONOₓ value when the second NH₃ storage is greater than the second NH₃ target for the time interval. The process 1000 can include determining whether the ratio between the first SONOₓ value and the second SONOₓ value is greater than a second threshold value. If the ratio between the first SONOₓ value and the second SONOₓ value is greater than the second threshold value, this can indicate that the aftertreatment system has a negative bias.

The process 1000 can include determining a maximum SONOₓ value and a minimum SONOₓ value (1020). For example, the process 1000 can include determining the maximum SONOₓ value when the second NH₃ storage is greater than the second NH₃ target. The process 1000 can include determining a minimum SONOₓ value when the second NH₃ storage is greater than the second NH₃ target.

The process 1000 can include determining a ratio between the maximum SONOₓ value and the minimum SONOₓ value (1025). The ratio can include the ratio between (1) the maximum SONOₓ value when the second NH₃ storage is greater than the second NH₃ target and (2) the minimum SONOₓ value when the second NH₃ storage is greater than the second NH₃ target. The process 1000 can include determining whether the ratio between the maximum SONOₓ value and the minimum SONOₓ value is greater than a third threshold value. If the ratio between the maximum SONOₓ value and the minimum SONOₓ value is greater than the third threshold value, this can indicate that the aftertreatment system has a positive bias.

The process 1000 can include controlling an amount of reductant (1030). For example, the process 1000 can include controlling the amount of reductant inserted into the decomposition chamber 118 based on at least one of the ratio between the first SONOₓ value and the second SONOₓ value or the ratio between the maximum SONOₓ value and the minimum SONOₓ value. The process 1000 can include increasing the amount of reductant dosing to the aftertreatment system in response to a determination that the ratio between the first SONOₓ value and the second SONOₓ value is greater than the second threshold value. The process 1000 can include decreasing the amount of reductant dosing to the aftertreatment system in response to a determination that the ratio between the maximum SONOₓ value and the minimum SONOₓ value is greater than the third threshold value.

The process 1000 can include determining an overall conversion efficiency of the aftertreatment system for the time interval. The process 1000 can include determining whether the overall conversion efficiency is less than a fourth threshold value. The process 1000 can include determining the ratio between the first SONOₓ value and the second SONOₓ value and the ratio between the maximum SONOₓ value and the minimum SONOₓ value in response to a determination that the overall conversion efficiency is less than the fourth threshold value.

For small bias detection, the SONOₓ can be checked before and after NH₃ storage is equal to NH₃ target transient. The SONOₓ can increase when NH₃ storage and NH₃ target change from NH₃ storage>NH₃ target to NH₃ target>NH₃ storage. The minimum SONOₓ can occur at NH₃ storage>NH₃ target. The SONOₓ can be checked before and after NH₃ storage is equal to NH₃ target transient. The ratio between SONOₓ (NH₃ target>NH₃ storage) and SONOₓ (NH₃ storage>NH₃ target) can be calculated. In a nominal system (e.g., a system that has no bias), the minimum SONOₓ can occur when the NH₃ storage is equal to the NH₃ target. If the minimum SONOₓ does not appear during the transient, and there is high ratio between SONOₓ at high NH₃ target and at high NH₃ storage, then the process 1000 can detect negative bias.

For small bias detection, the SONOₓ can be checked when NH₃ storage>NH₃ target. SONOₓ can increase when NH₃ storage and NH₃ target change from NH₃ storage>NH₃ target to NH₃ target>NH₃ storage. The minimum SONOₓ can occur at NH₃ target>NH₃ storage. The ratio between SONOₓ at beginning of the duration that NH₃ storage>NH₃ target and maximum SONOₓ during the duration that NH₃ storage>NH₃ target can be calculated. In the nominal system, there may not be a significant increase of SONOₓ when NH₃ storage changes to higher than NH₃ target. If there is a high ratio between SONOₓ at higher storage and less high storage (e.g., just after NH₃ storage is equal to NH₃ target transient), then the process 1000 can detect positive bias.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

The operations described in this specification can be performed by a data processing apparatus on data stored on one or more computer-readable storage devices or received from other sources. The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, subprograms, or portions of code). A computer program can be deployed to be executed on one computer or on multiple computers that are located at one site or distributed across multiple sites and interconnected by a communication network.

Processors suitable for the execution of a computer program include, by way of example, microprocessors, and any one or more processors of a digital computer. A processor can receive instructions and data from a read only memory or a random-access memory or both. The elements of a computer are a processor for performing actions in accordance with instructions and one or more memory devices for storing instructions and data. A computer can include, or be operatively coupled to receive data from or transfer data to, or both, one or more mass storage devices for storing data, e.g., magnetic, magneto optical disks, or optical disks. A computer need not have such devices. Moreover, a computer can be embedded in another device, e.g., a personal digital assistant (PDA), a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The implementations described herein can be implemented in any of numerous ways including, for example, using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to or receive communications from other devices. The display unit(s) may be provided, for example, to allow a user to view various information in connection with execution of the instructions. The user input device(s) may be provided, for example, to allow the user to make manual adjustments, make selections, enter data or various other information, or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the solution discussed above. The computer readable medium or media can be transportable, such that the program or programs stored thereon can be loaded onto one or more different computers or other processors to implement various aspects of the present solution as discussed above.

The methods described herein, or operations thereof, may be implemented in machine-readable medium for execution by various types of processors of the controller. A circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

The computer readable medium (also referred to herein as machine-readable media or machine-readable content) may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. As alluded to above, examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. As also alluded to above, computer readable program code embodied on a computer readable signal medium may be transmitted using any appropriate medium, including but not limited to wireless, wireline, optical fiber cable, Radio Frequency (RF), or the like, or any suitable combination of the foregoing. In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The computer readable program code may execute entirely on a local computer (such as via the controller 150 of FIG. 1), partly on the local computer, as a stand-alone computer-readable package, partly on the local computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As used herein, the term “about,” or similar terms, generally mean plus or minus 10% of the stated value. For example, about 0.5 would include 0.45 and 0.55, about 10 would include 9 to 11, about 1000 would include 900 to 1100.

The term “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements; values of parameters, mounting arrangements; use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes, and omissions may also be made in the design, operating conditions, and arrangement of the various exemplary embodiments without departing from the scope of the present embodiments.

While this specification contains many specific implementation details, these should not be construed as limitations on the scope of any embodiments or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A non-transitory computer-readable medium for use with an aftertreatment system that comprises a catalyst and a decomposition chamber upstream of the catalyst, the medium having computer-readable instructions stored thereon that, when executed by at least one controller, cause the at least one controller to:
determine, for a time interval, an estimated deNOₓ—NH₃ ratio defined by:
$$estimated {deNO}_{x} - {NH}_{3} ratio = \frac{a c c u m u lated inlet {NO}_{x} - accumulated outlet {NO}_{x}}{injected {NH}_{3} + N {H}_{3} storage change - N {H}_{3} slip} ,$$
wherein the accumulated inlet NOₓ comprises an amount of NOₓ in exhaust gas at an inlet of the catalyst, the accumulated outlet NOₓ comprises an amount of NOₓ in the exhaust gas at an outlet of the catalyst, the injected NH₃ comprises an amount of NH₃ injected into the decomposition chamber, the NH₃ storage change comprises a change of an amount of NH₃ stored in the catalyst, and the NH₃ slip comprises an amount of NH₃ at an outlet of the aftertreatment system; and
control an amount of reductant inserted into the decomposition chamber based on at least the estimated deNOₓ—NH₃ ratio.

2. The non-transitory computer-readable medium of claim 1, wherein the at least one controller is configured to:
determine an overall conversion efficiency of the catalyst for the time interval;
determine whether the overall conversion efficiency is less than a first threshold value; and
determine the estimated deNOₓ—NH₃ ratio in response to a determination that the overall conversion efficiency is less than the first threshold value.

3. The non-transitory computer-readable medium of claim 1, wherein the at least one controller is configured to:
determine a system-out NOₓ (SONOₓ) value;
determine whether the SONOₓ value is greater than a second threshold value; and
determine the estimated deNOₓ—NH₃ ratio in response to a determination that the SONOₓ value is greater than the second threshold value.

4. The non-transitory computer-readable medium of claim 1, wherein the at least one controller is configured to:
determine whether the estimated deNOₓ—NH₃ ratio is less than a third threshold value; and
decrease a long-term trim gain parameter in response to a determination that the estimated deNOₓ—NH₃ ratio is less than the third threshold value.

5. The non-transitory computer-readable medium of claim 1, wherein the at least one controller is configured to:
determine whether the estimated deNOₓ—NH₃ ratio is greater than a third threshold value; and
increase a long-term trim gain parameter in response to a determination that the estimated deNOₓ—NH₃ ratio is greater than the third threshold value.

6. The non-transitory computer-readable medium of claim 1, wherein the time interval is a first time interval and wherein the at least one controller is configured to:
modify a long-term trim gain parameter in response to a determination that the estimated deNOₓ—NH₃ ratio is greater than or less than a third threshold value;
determine, for a second time interval subsequent to the first time interval, an overall conversion efficiency and a SONOₓ value;
determine whether the overall conversion efficiency is less than a first threshold value or whether the SONOₓ value is greater than a second threshold value; and
reset the long-term trim gain parameter to a value before modification of the long-term trim gain parameter in response to a determination that the overall conversion efficiency, for the second time interval subsequent to the first time interval, is less than the first threshold value or to a determination that the SONOₓ value is greater than the second threshold value.

7. The non-transitory computer-readable medium of claim 1, wherein the time interval is a first time interval and wherein the at least one controller is configured to:
determine, for a third time interval, an average of a first plurality of SONOₓ values for the aftertreatment system;
determine, for a fourth time interval, an average of a second plurality of SONOₓ values for the aftertreatment system;
determine whether the average of the first plurality of SONOₓ values is greater than a fourth threshold value;
determine whether the average of the second plurality of SONOₓ values is greater than the fourth threshold value;
determine whether NH₃ slip has occurred during the third time interval and the fourth time interval; and
decrease a long-term trim gain parameter in response to a determination that the average of the first plurality of SONOₓ values is greater than the fourth threshold value, a determination that the average of the second plurality of SONOₓ values is greater than the fourth threshold value, and a determination that NH₃ slip has not occurred during the third time interval and the fourth time interval.

8. The non-transitory computer-readable medium of claim 1, wherein the at least one controller is configured to:
determine whether the estimated deNOₓ—NH₃ ratio is greater than a third threshold value;
determine whether NH₃ slip has occurred during the time interval; and
increase a long-term trim gain parameter in response to a determination that the estimated deNOₓ—NH₃ ratio is greater than the third threshold value and a determination that NH₃ slip has occurred during the time interval.

9. The non-transitory computer-readable medium of claim 1, wherein the time interval is a first time interval and wherein the at least one controller is configured to:
determine whether the estimated deNOₓ—NH₃ ratio is greater than a third threshold value;
determine whether NH₃ slip has occurred during a second time interval prior to the first time interval;
determine whether an ammonia to NOₓ (ANR) ratio is less than a fifth threshold value; and
increase a long-term trim gain parameter in response to a determination that the estimated deNOₓ—NH₃ ratio is greater than the third threshold value, a determination that NH₃ slip has occurred during the second time interval prior to the first time interval, and a determination that the ANR ratio is less than the fifth threshold value.

10. The non-transitory computer-readable medium of claim 1, wherein the time interval is a first time interval and wherein the at least one controller is configured to:
reset a long-term trim gain parameter to a value before modification of the long-term trim gain parameter.

11. An aftertreatment system comprising:
the at least one controller of claim 1;
an SCR inlet NOₓ sensor configured to receive inlet NOₓ values during the time interval; and
an SCR outlet NOₓ sensor configured to receive outlet NOₓ values during the time interval.

12. A method, comprising:
determining, by at least one controller, for a first time interval, an average of a first plurality of SONOₓ values for an aftertreatment system that comprises a catalyst and a decomposition chamber upstream of the catalyst;
determining, by the at least one controller, for a second time interval, an average of a second plurality of SONOₓ values for the aftertreatment system;
determining, by the at least one controller, whether the average of the first plurality of SONOₓ values is greater than a first threshold value;
determining, by the at least one controller, whether the average of the second plurality of SONOₓ values is greater than the first threshold value;
determining, by the at least one controller, whether NH₃ slip has occurred during the first time interval and the second time interval; and
controlling, by the at least one controller, an amount of reductant inserted into the decomposition chamber based on at least a determination that the average of the first plurality of SONOₓ values is greater than the first threshold value, a determination that the average of the second plurality of SONOₓ values is greater than the first threshold value, and a determination that NH₃ slip has not occurred during the first time interval and the second time interval.

13. The method of claim 12, comprising:
decreasing, by the at least one controller, a long-term trim gain parameter in response to a determination that the average of the first plurality of SONOₓ values is greater than the first threshold value, a determination that the average of the second plurality of SONOₓ values is greater than the first threshold value, and a determination that NH₃ slip has not occurred during the first time interval and the second time interval.

14. The method of claim 13, comprising:
determining, by the at least one controller, for a third time interval subsequent to the first time interval and the second time interval, an overall conversion efficiency and a SONOₓ value;
determining, by the at least one controller, whether the overall conversion efficiency is less than a second threshold value or whether the SONOₓ value is greater than a third threshold value; and
resetting, by the at least one controller, the long-term trim gain parameter to a value before decrement of the long-term trim gain parameter in response to a determination that the overall conversion efficiency is less than the second threshold value or to a determination that the SONOₓ value is greater than the third threshold value.

15. The method of claim 12, comprising:
determining, by the at least one controller, for a time interval, an estimated deNOₓ—NH₃ ratio defined by:
$$estimated {deNO}_{x} - {NH}_{3} ratio = \frac{a c c u m u lated inlet {NO}_{x} - accumulated outlet {NO}_{x}}{injected {NH}_{3} + N {H}_{3} storage change - N {H}_{3} slip} ,$$
wherein the accumulated inlet NOₓ comprises an amount of NOₓ in exhaust gas at an inlet of the catalyst, the accumulated outlet NOₓ comprises an amount of NOₓ in the exhaust gas at an outlet of the catalyst, the injected NH₃ comprises an amount of NH₃ injected into the decomposition chamber, the NH₃ storage change comprises a change of an amount of NH₃ stored in the catalyst, and the NH₃ slip comprises an amount of NH₃ at an outlet of the aftertreatment system; and
controlling, by the at least one controller, the amount of reductant inserted into the decomposition chamber based on at least the estimated deNOₓ—NH₃ ratio.

16. The method of claim 15, comprising:
determining, by the at least one controller, whether the estimated deNOₓ—NH₃ ratio is less than a second threshold value; and
decreasing, by the at least one controller, a long-term trim gain parameter in response to a determination that the estimated deNOₓ—NH₃ ratio is less than the second threshold value.

17. A non-transitory computer-readable medium for use with an aftertreatment system that comprises a catalyst and a decomposition chamber upstream of the catalyst, the medium having computer-readable instructions stored thereon that, when executed by at least one controller, cause the at least one controller to:
determine a time interval when accumulated inlet NOₓ is greater than a first threshold value;
determine a first SONOₓ value when a first NH₃ target is greater than a first NH₃ storage for the time interval;
determine a second SONOₓ value when a second NH₃ storage is greater than a second NH₃ target for the time interval;
determine a ratio between the first SONOₓ value and the second SONOₓ value;
determine a maximum SONOₓ value when the second NH₃ storage is greater than the second NH₃ target;
determine a minimum SONOₓ value when the second NH₃ storage is greater than the second NH₃ target;
determine a ratio between the maximum SONOₓ value and the minimum SONOₓ value; and
control an amount of reductant inserted into the decomposition chamber based on at least one of the ratio between the first SONOₓ value and the second SONOₓ value or the ratio between the maximum SONOₓ value and the minimum SONOₓ value.

18. The non-transitory computer-readable medium of claim 17, wherein the at least one controller is configured to:
determine whether the ratio between the first SONOₓ value and the second SONOₓ value is greater than a second threshold value; and
increase the amount of reductant dosing to the aftertreatment system in response to a determination that the ratio between the first SONOₓ value and the second SONOₓ value is greater than the second threshold value.

19. The non-transitory computer-readable medium of claim 17, wherein the at least one controller is configured to:
determine whether the ratio between the maximum SONOₓ value and the minimum SONOₓ value is greater than a third threshold value; and
decrease the amount of reductant dosing to the aftertreatment system in response to a determination that the ratio between the maximum SONOₓ value and the minimum SONOₓ value is greater than the third threshold value.

20. The non-transitory computer-readable medium of claim 17, wherein the at least one controller is configured to:
determine an overall conversion efficiency of the aftertreatment system for the time interval;
determine whether the overall conversion efficiency is less than a fourth threshold value; and
determine the ratio between the first SONOₓ value and the second SONOₓ value and the ratio between the maximum SONOₓ value and the minimum SONOₓ value in response to a determination that the overall conversion efficiency is less than the fourth threshold value.
